(19) United States
(12) Patent Application Publication
(10) Pub. No.: US 2026/0208587 A1
(43) Pub. Date: Jul. 23, 2026

(54) DISPLAY CONTROL DEVICE, DISPLAY CONTROL METHOD, AND STORAGE MEDIUM

(71) Applicant: TOYOTA JIDOSHA KABUSHIKI KAISHA, Toyota-shi Aichi-ken (JP)

(72) Inventor: Satoshi Naito, Yokohama-shi Kanagawa-ken (JP)

(73) Assignee: TOYOTA JIDOSHA KABUSHIKI KAISHA, Toyota-shi Aichi-ken (JP)

(21) Appl. No.: 19/449,828

(22) Filed: Jan. 15, 2026

(30) Foreign Application Priority Data
Jan. 20, 2025 (JP) 2025-008005

(51) Int. Cl. B60K 35/81; B60K 35/22

(52) U.S. Cl. CPC B60K 35/81; B60K 35/22; B60K 2360/122

(57) ABSTRACT

Short cut buttons are displayed on the basic screen of a display device. When replacing the functions assigned to the short cut buttons with other functions, the function replacement short cut button for which the function is to be replaced is selected from among the plurality of short cut buttons displayed on the basic screen of the display device. At that time, the short cut button to which is assigned the function not burdening a user the most when performing the on/off setting operations of the function without using the short cut button is selected as the function replacement short cut button among the functions assigned to the short cut buttons.

### DESCRIPTION

### CROSS-REFERENCE TO RELATED APPLICATIONS

This application claims priority to Japanese Patent Application No. 2025-008005 filed January 20, 2025, the entire contents of which are herein incorporated by reference.

### FIELD

The present disclosure relates to a display control device, display control method, and storage medium.

### BACKGROUND

Known in the art is an information apparatus designed to display vehicle function buttons, that is, short cut buttons, for calling up specific functions relating to operation of a vehicle, on a menu screen of a display device mounted in the vehicle (for example, see Japanese Unexamined Patent Publication No. 2024-49711). This information apparatus is designed to acquire the frequencies of use of the different functions relating to operation of the vehicle separated into use while the vehicle is moving and while the vehicle is stopped, display function buttons, that is, short cut buttons, for calling up functions judged to be high in frequency of use while the vehicle was moving when the vehicle is moving, and display function buttons, that is, short cut buttons, for calling up functions judged to be high in frequency of use while the vehicle was stopped when the vehicle is stopped.

### SUMMARY

In this regard, in recent years, in automobiles, for example, the work of updating software for control of various function by wireless communication and adding new functions or updating existing functions are frequently performed. In this case, among the users, there are users who wish to immediately actively use these added new functions or updated existing functions. Therefore, if considering such users, immediately assigning these added new functions or updated existing functions to the short cut buttons can be said to be desirable. In this regard, however, the number of short cut buttons able to be displayed is limited. Therefore, to immediately assign the added new function or updated existing function to the short cut button, it becomes necessary to replace the function already assigned to the short cut button.

In this case, the question becomes which of the short cut buttons the new function desirably replaces the function already assigned, but in the above known information apparatus, this is not considered at all.

According to the present disclosure, there is provided a display control device for controlling a screen display of a display device mounted in a vehicle, the display control device comprising

a short cut button display control unit for making a plurality of short cut buttons be displayed on a basic screen of the display device and

a function replacement short cut button selection unit for selecting from among a plurality of the short cut buttons displayed on the basic screen of the display device a function replacement short cut button for which a replacement of the function is performed when replacing the function assigned to the short cut button with another function,

the function replacement short cut button selection unit selecting as the function replacement short cut button a short cut button to which is assigned a function not burdening a user the most when performing on/off setting operations of the function without using the short cut button among the functions assigned to the short cut buttons.

Furthermore, according to the present disclosure, there is provided a display control method for controlling a screen display of a display device mounted in a vehicle, the display control method causing a computer to

make a plurality of short cut buttons be displayed on a basic screen of the display device and

select from among a plurality of the short cut buttons displayed on the basic screen of the display device a function replacement short cut button for which a replacement of the function is performed when replacing the function assigned to the short cut button with another function and at that time select as the function replacement short cut button a short cut button to which is assigned a function not burdening a user the most when performing on/off setting operations of the function without using the short cut button among the functions assigned to the short cut buttons.

Furthermore, according to the present disclosure, there is provided a storage medium storing a program used for controlling a screen display of a display device mounted in a vehicle, the program causing a computer to

make a plurality of short cut buttons be displayed on a basic screen of the display device and

select from among a plurality of the short cut buttons displayed on the basic screen of the display device a function replacement short cut button for which a replacement of the function is performed when replacing the function assigned to the short cut button with another function and at that time select as the function replacement short cut button a short cut button to which is assigned a function not burdening a user the most when performing on/off setting operations of the function without using the short cut button among the functions assigned to the short cut buttons.

It is possible to select an optimal short cut button as a short cut button to which another function is assigned.

### BRIEF DESCRIPTION OF DRAWINGS

FIG. 1 is a top view of a vehicle shown schematically.

FIG. 2 is a view showing a functional configuration of a vehicle.

FIG. 3A is a view schematically showing a basic screen of a display device.

FIG. 3B is a view schematically showing a basic screen of a display device.

FIG. 4A is a view schematically showing a screen of a display device.

FIG. 4B is a view schematically showing a screen of a display device.

FIG. 5 is a view schematically showing a screen of a display device.

FIG. 6A is a view schematically showing a screen of a display device.

FIG. 6B is a view schematically showing a screen of a display device.

FIG. 7A is a view schematically showing a screen of a display device.

FIG. 7B is a view schematically showing a screen of a display device.

FIG. 8 is a flow chart for performing processing for setting functions on/off without using short cut buttons.

FIG. 9 is a flow chart for performing processing for setting functions on/off by using short cut buttons.

FIG. 10 is a view schematically showing a screen of a display device.

FIG. 11 is a view schematically showing a screen of a display device.

FIG. 12A is a view showing the relationship between the on/off operations of the power of the vehicle and the on/off setting operations of the function M.

FIG. 12B is another view showing the relationship between the on/off operations of the power of the vehicle and the on/off setting operations of the function M.

FIG. 12C is another view showing the relationship between the on/off operations of the power of the vehicle and the on/off setting operations of the function M.

FIG. 13A is a view showing the relationship between the on/off operations of the power of the vehicle and the on/off setting operations of the function M.

FIG. 13B is another view showing the relationship between the on/off operations of the power of the vehicle and the on/off setting operations of the function M.

FIG. 14 is a view schematically showing levels on the screen of the display device.

FIG. 15 is a view schematically showing a list of the number of the on/off setting operations of the functions etc. in each trip.

FIG. 16 is a flow chart for performing a processing for preparing a list.

FIG. 17 is a flow chart for performing a processing for selecting the function replacement short cut button.

FIG. 18 is a flow chart for performing a processing for selecting the function replacement short cut button.

FIG. 19 is a flow chart for performing a processing for selecting the function replacement short cut button.

FIG. 20 is a flow chart for performing a processing for replacement of function of the short cut button.

FIG. 21 is a flow chart for performing a processing for replacement of function of the short cut button.

FIG. 22 is a view explaining the combination of the ratio X of number of the trip and the frequency Y of performance of the setting operation.

FIG. 23 is a view showing a list of the short cut buttons to be selected as the function replacement short cut button.

FIG. 24 is a view explaining the combination of the ratio X of number of the trip and the on/off setting screen display level Z.

FIG. 25 is a view explaining the combination of the on/off setting screen display level Z and the frequency Y of performance of the setting operation.

FIG. 26 is a flow chart for performing a processing for selecting the function replacement short cut button.

FIG. 27 is a flow chart for performing a processing for selecting the function replacement short cut button.

FIG. 28 is a flow chart for performing a processing for selecting the function replacement short cut button.

FIG. 29 is a view explaining the combination of the ratio X of number of the trip, the frequencies Y of performance of the setting operation and the on/off setting screen display level Z.

FIG. 30 is a flow chart for performing a processing for selecting the function replacement short cut button.

### DESCRIPTION OF EMBODIMENTS

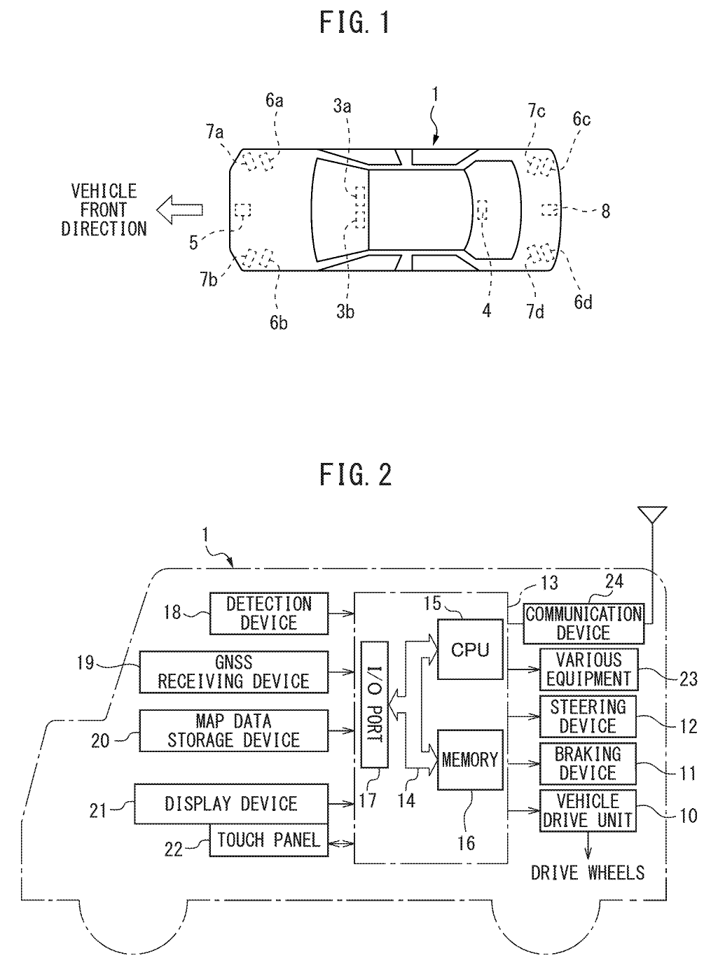

FIG. 1 schematically shows a vehicle 1 when viewed from above, while FIG. 2 shows the functional configuration of the vehicle 1 shown in FIG. 1. Note that, this vehicle 1 can be driven by either manual driving and autonomous driving. If referring to FIG. 2, 10 indicates a vehicle drive unit for imparting drive force to drive wheels of the vehicle 1, 11 indicates a braking device for braking the vehicle 1, 12 indicates a steering device for steering the vehicle 1, and 13 indicates an electronic control unit mounted in the vehicle 1. As shown in FIG. 2, the electronic control unit 13 is comprised of a digital computer and is provided with a CPU (processor) 15, a memory 16 comprised of a ROM and RAM, and an input/output port 17 which are connected with each other by a bidirectional bus 14.

On the other hand, as shown in FIG. 2, in the vehicle 1, a detection device 18 including various types of sensors required when the vehicle 1 is being manually driven or automatically driven is arranged. This detection device 18 includes sensors for detecting the state of the vehicle 1 and sensors for detecting the surroundings of the vehicle 1. In this case, as sensors for detecting the state of the vehicle 1, an acceleration sensor, speed sensor, azimuth sensor, and geomagnetic sensor are used. As sensors for detecting the surroundings of the vehicle 1, cameras for capturing the areas in front of, at the sides of, and at the back of the vehicle 1, and lidars, radars, clearance sonars, etc. for detecting the areas in front of, at the sides of, and at the back of the vehicle 1 are used.

FIG. 1 shows one example of the sensors arranged in the vehicle 1. In the example shown in FIG. 1, visible light cameras 3a, 3b for capturing the area in front of the vehicle 1, a rear camera 4 for capturing the area in back of the vehicle 1, a long distance millimeter wave radar 5 for emitting millimeter waves toward the area in front of the vehicle 1, medium distance millimeter wave radars 6a, 6b, 6c, and 6d for emitting millimeter waves toward the areas at the sides of the vehicle 1, lidars 7a, 7b, 7c, and 7d for firing laser beams toward the areas at the sides of the vehicle 1, and clearance sonar 8 for emitting ultrasonic waves toward the area in back of the vehicle 1 are arranged in the vehicle 1. Note that, the method of setting the cameras and sensors shown in FIG. 1 shown is just an example. There are various methods for arranging these cameras and sensors.

Returning again to FIG. 2, the vehicle 1 is provided with a GNSS (global navigation satellite system) receiving device 19, map data storage device 20, and display device 21. The GNSS receiving device 19 can detect a current position of the vehicle 1 (for example, the latitude and longitude of the vehicle 1) based on information obtained from a plurality of artificial satellites. Therefore, it is possible to acquire the current position of the vehicle 1 by this GNSS receiving device 19. As this GNSS receiving device 19, for example, a GPS receiving device is used. Further, in the map data storage device 20, the map data etc. necessary for the vehicle 1 to run is stored. The detection device 18, the GNSS receiving device 19, and the map data storage device 20 are connected to the electronic control unit 13.

The display device 21 is arranged inside the vehicle compartment and has a screen able to be viewed by the user of the vehicle 1, for example, the driver of the vehicle 1. A pressure sensitive type, electrostatic inductance type, or electrostatic capacity type thin film shaped touch panel 22 is integrally formed on the screen of the display device 21. These display device 21 and touch panel 22 are connected to the electronic control unit 13. Further, headlights, turn lights, inside compartment lights, an air-conditioner, and other various devices 23 are arranged in the vehicle 1. These various devices 23 are connected to the electronic control unit 13. A communication device 24 for receiving television broadcasts, radio broadcasts, traffic information, etc. and trading signals with information centers or other vehicles is mounted in the vehicle 1. This communication device 24 is connected to the electronic control unit 13.

In the example shown in FIG. 2, the vehicle drive unit 10 of the vehicle 1 is comprised of an electric motor driven by a secondary battery or an electric motor driven by a fuel cell. The drive wheels are controlled in drive by these electric motors in accordance with output signals of the electronic control unit 13. Further, the braking of the vehicle 1 is controlled by the braking device 11 in accordance with output signals of the electronic control unit 13, while the steering of the vehicle 1 is controlled by the steering device 12 in accordance with output signals of the electronic control unit 13.

First, the meanings of the terms used in this Description will be simply explained.

In this Description, “power on” indicates “a state where the vehicle 1 can be controlled in drive” while “power off” indicates “a state where the vehicle 1 cannot be controlled in drive”.

Further, in this Description, “function on” indicates “a state where a function is activated or a state where a function can be activated” while “function off” indicates “a state where a function is deactivated”.

Further, in this Description, “a function is set on” indicates “a function is set so that the function is activated” while “a function is set off” indicates “a function is set so that the function is deactivated”.

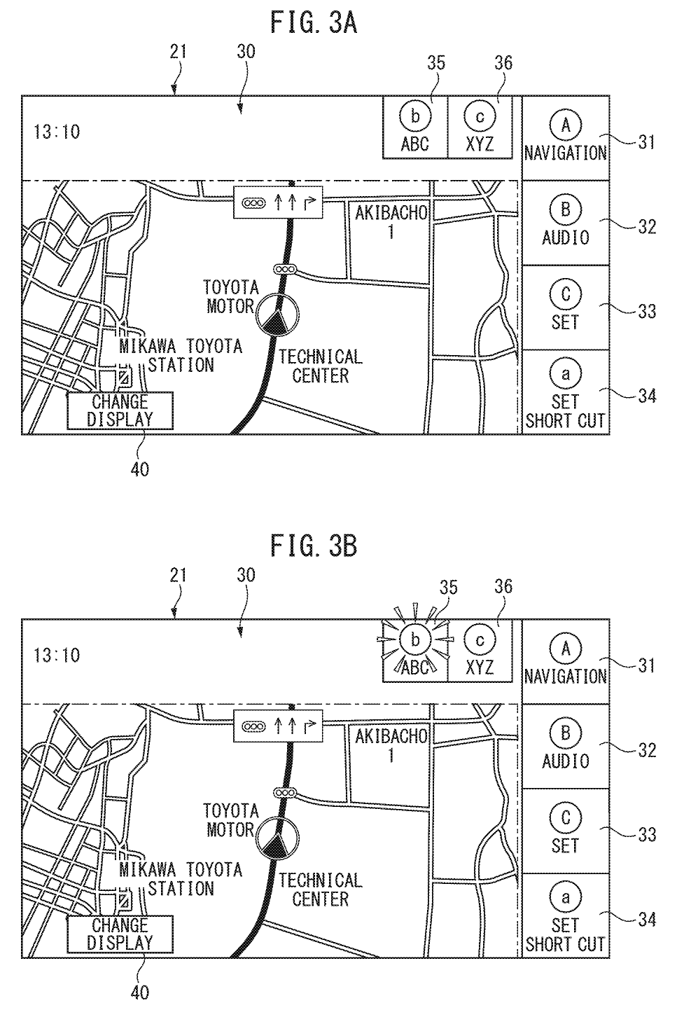

Next, referring to FIG. 3A, the screen 30 of the display device 21 used in an embodiment according to the present disclosure will be explained. If the display device 21 is started up, as shown in FIG. 3A, a button 31 for a navigation function which is one of the basic functions, a button 32 for an audio function which is one of the basic functions, and a button 33 for a setting function which is one of the basic functions are displayed on the surroundings of the screen 30 of the display device 21. At this time, as shown in FIG. 3A, for example, a road map is displayed on the screen 30 of the display device 21. In this Description, the screen 30 on which the button 31 for a navigation function which is one of the basic functions, the button 32 for an audio function which is one of the basic functions, and the button 33 for a setting function which is one of the basic functions are displayed like when the display device 21 is started up will be called a “basic screen”.

Note that, in the embodiment shown in FIG. 3A, a layer of the thin film shaped touch panel 22 is formed on the screen 30 of the display device 21. In FIG. 3A, if buttons displayed on the screen 30 such as the navigation function button 31, audio function button 32, and setting function button 33 are touched, the fact of the buttons being touched is recognized by the electronic control unit 13 through the touch panel 22. In this Description, the fact of buttons being displayed on the screen 30 so that the fact of buttons being touched is recognized by the electronic control unit 13 will be referred to simply as the buttons being displayed on the screen 30. Note that, in FIG. 3A, the marks A, B, C and letters illustrate schematically icons showing the navigation function, audio function, and setting function.

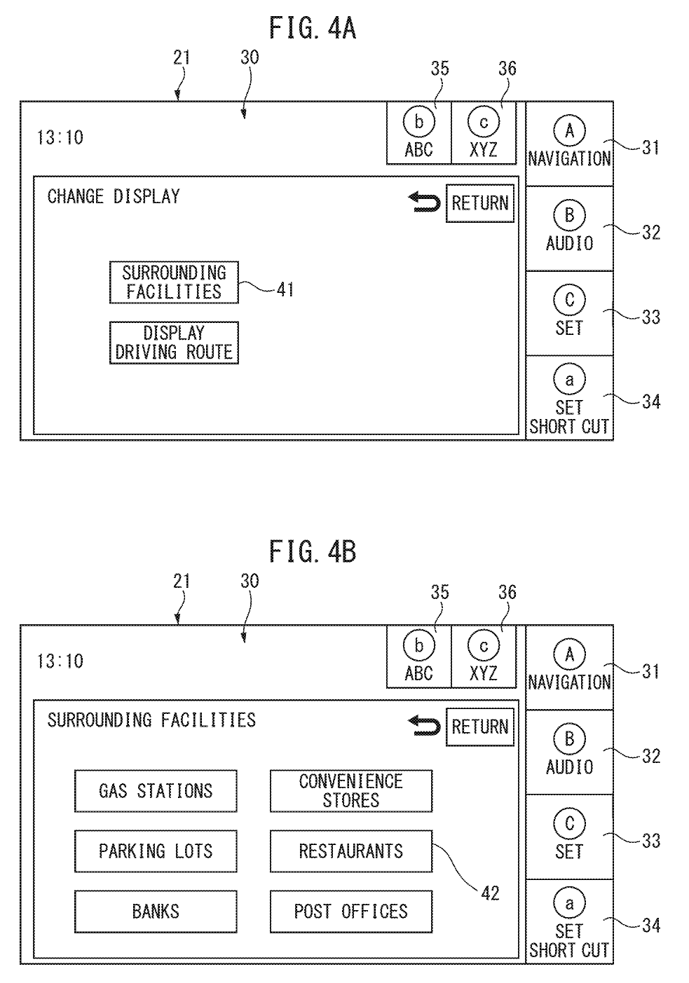

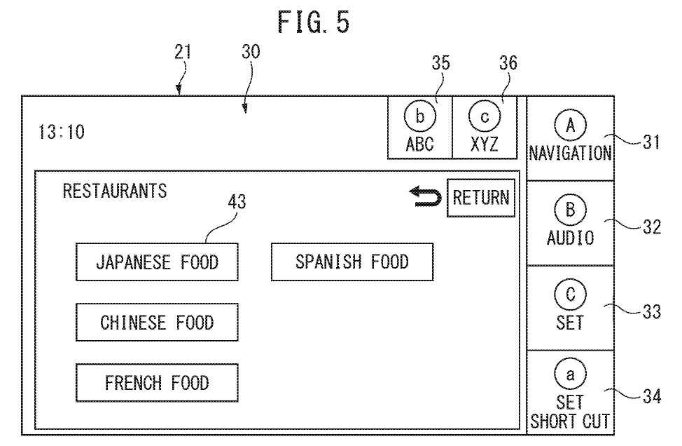

Next, one example of the button operation in these basic functions will be simply explained. FIG. 3A shows the case where the button 31 for a navigation function is touched and a road map is displayed on the basic screen of the display device 21. If a display changing button 40 provided on this road map is touched, the road map is switched to a display changing screen such as shown in FIG. 4A positioned one level lower. Next, if, for example, a surrounding facility button 41 which is displayed on this display changing screen is touched, the display changing screen is switched to a surrounding facility selection screen such as shown in FIG. 4B positioned one further level lower. Next, if, for example, a restaurant button 42 which is displayed on this surrounding facility selection screen is touched, the surrounding facility selection screen is switched to a restaurant selection screen such as shown in FIG. 5 and positioned a further one level lower. Next, if for example a Japanese food button 43 displayed on this restaurant selection screen is touched, the restaurant selection screen is switched to the road map screen shown in FIG. 3A and the positions of Japanese restaurants are displayed on the road map.

In this way, in this example, by the Japanese food button 43 positioned at a deep level being touched, the Japanese food restaurant position display function for displaying the positions of Japanese food restaurants on the road map is set on, the Japanese food restaurant position display function is activated, and the positions of Japanese food restaurants are displayed on the road map. In this case, for example, when the positions of Japanese food restaurants are displayed on the road map, if the button 31 for navigation function use is touched, the Japanese food restaurant position display function is set off and the display of the positions of the Japanese food restaurants disappears from this road map. Note that the road map screen, display changing screen, surrounding facility selection screen, and restaurant selection screen respectively shown in FIG. 3A, FIG. 4A, FIG. 4B, and FIG. 5 usually display a plurality of other buttons, but FIG. 3A, FIG. 4A, FIG. 4B, and FIG. 5 omit display of these plurality of other buttons.

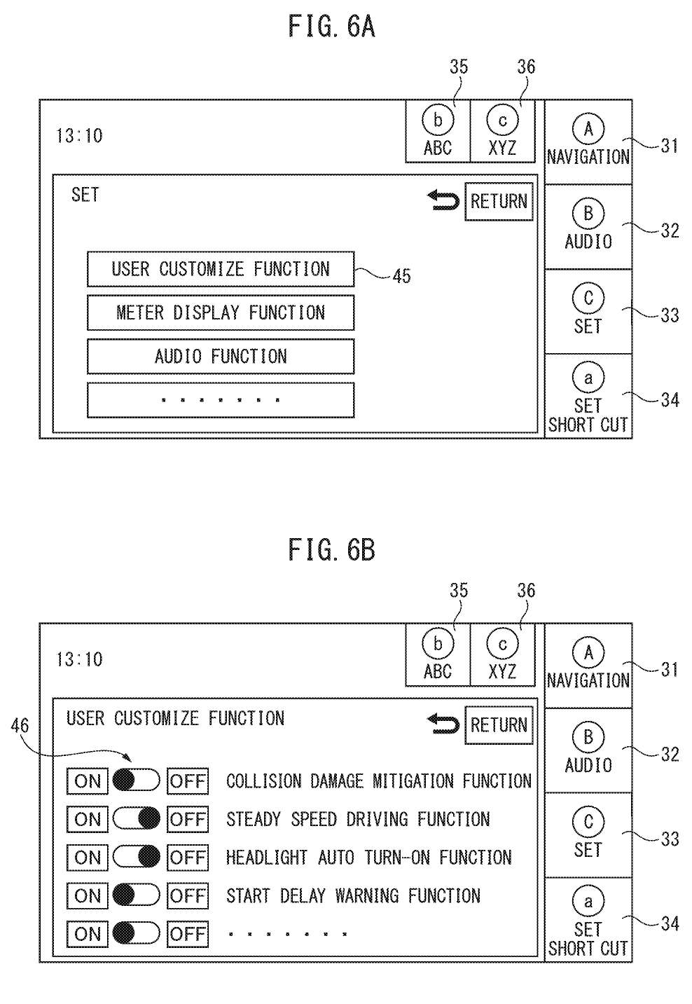

On the other hand, when, for example, the road map is displayed on the basic screen of the display device 21 such as shown in FIG. 3A, if the setting button 33 is touched, the road map is switched to a setting screen such as shown in FIG. 6A positioned one level lower. Next, if, for example, a user customize function button 45 displayed on this setting screen is touched, the setting screen is switched to a user customize function selection screen such as shown in FIG. 6B positioned one further level lower. In the example shown in FIG. 6B, an on-off display 46 is displayed on the user customize function selection screen for showing whether respective functions are currently on or off.

Here, if simply explaining the functions displayed on the user customize function selection screen, a collision damage mitigating function is a function of using the braking device 11 to impart a braking force to the vehicle 1 when a state where the vehicle 1 approaches another vehicle from the rear is detected by the detection device 18, a steady speed driving function is a function of making the vehicle 1 run at a steady speed which is set, a headlight auto turn-on function is a function of automatically turning on the headlights when the brightness of the surroundings becomes a threshold value or less, and a start delay warning function is a function of issuing a warning when for example the vehicle 1 continues to be stopped despite another vehicle stopped in front of the vehicle 1 starting to move. Note that, in FIG. 6A and FIG. 6B, the expression “…….” means there is a description, but details of the description are omitted. The same is true below.

That is, the functions described in FIG. 6B are just part of the functions listed on the user customize function selection screen. In actuality, the user customize function selection screen displays a far greater number of functions. In FIG. 6B, for example, if focusing on the headlight auto turn-on function, currently the headlight auto turn-on function is deactivated as will be understood from the on/off display 46. That is, the headlight auto turn-on function is set off. In this case, if touching the ON button of the headlight auto turn-on function, the headlight auto turn-on function changes from the off setting to the on setting and the on/off display 46 changes to show an on setting. In this way, in this example, by touching the corresponding button on the user customize function selection screen positioned at the deepest level, it is possible to switch all of the functions from the off setting to the on setting or switch them from the on setting to the off setting.

In this way, the buttons for setting functions on or setting them off are positioned at the deep level. However, in this way, if the buttons are positioned at the deep level, time is taken for operating the buttons. In particular, if the buttons of functions often utilized by a user are positioned at the deep level, for the user, operation of the button becomes considerably burdensome. Therefore, to lighten the burden on the user, in an embodiment according to the present disclosure, as shown in FIG. 3A, two short cut buttons 35, 36 for operation to which respectively different functions are assigned are displayed on the basic screen of the display device 21. Of course, three or more of such short cut buttons can also be displayed, but below, an embodiment according to the present disclosure will be explained with reference to an example of a case where two short cut buttons 35, 36 are displayed. Note that, in FIG. 3A, the marks “b”, “c” and letters ABC, XYZ schematically show icons.

In an embodiment according to the present disclosure, if touching the short cut button 35, when the function assigned to the short cut button 35 is currently set off, it is switched to an on setting. Due to this, the function assigned to the short cut button 35 is activated. Next, if touching the short cut button 35 one more time, the function assigned to the short cut button 35 is switched from the on setting to the off setting whereupon the function assigned to the short cut button 35 is deactivated. That is, each time touching the short cut button 35, the on setting and off setting of the function are switched whereupon activation of the function and deactivation of the function are switched.

Similarly, if touching the short cut button 36, when the function assigned to the short cut button 36 is currently set off, it is switched to an on setting. Due to this, the function assigned to the short cut button 36 is activated. Next, if touching the short cut button 36 one more time, the function assigned to the short cut button 36 is switched from the on setting to the off setting whereupon the function assigned to the short cut button 36 is deactivated. That is, each time touching the short cut button 36, the on setting and off setting of the function are switched whereupon activation of the function and deactivation of the function are switched.

Further, in an embodiment according to the present disclosure, if touching the short cut button 35, when the function assigned to the short cut button 35 is set off, the short cut button 35 is rendered off in display, while if the function assigned to the short cut button 35 is set on, the short cut button 35 is rendered on in display. Similarly, when the function assigned to the short cut button 36 is set off, the short cut button 36 is rendered off in display, while if the function assigned to the short cut button 36 is set on, the short cut button 36 is rendered on in display.

An example when the short cut button 35 is rendered off in display and when the short cut button 35 is rendered on in display is shown in FIG. 3A and FIG. 3B. In this example, when the short cut button 35 is the same brightness as the other buttons 31, 32, and 33 as shown in FIG. 3A, the display of the short cut button 35 is deemed off in display while when the short cut button 35 as a whole shines brightly or when the icon part of the short cut button 35 shines brightly as shown in FIG. 3B, the short cut button 35 is deemed on in display. Similarly, when the short cut button 36 is the same brightness as the other buttons 31, 32, and 33, the short cut button 36 is deemed off in display, while when the short cut button 36 as a whole shines brightly or when the icon part of the short cut button 36 shines brightly, the short cut button 36 is deemed on in display.

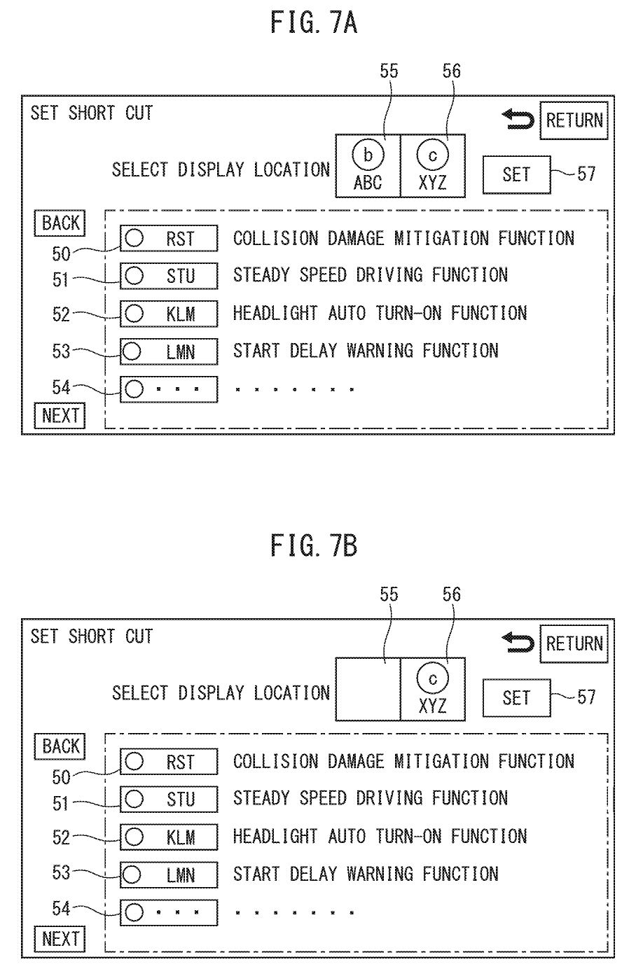

Further, in an embodiment according to the present disclosure, to assign functions to the short cut buttons 35, 36, as shown in FIG. 3A and FIG. 3B, a short cut setting button 34 is displayed on the basic screen of the display device 21. In this case, for example, if the short cut setting button 34 is touched when the road map is displayed on the basic screen of the display device 21 as shown in FIG. 3A, the road map is switched to a short cut setting screen positioned at one lower level such as shown in FIG. 7A. In the example shown in FIG. 7A, candidates of functions able to be assigned to the short cut buttons 35, 36 are displayed on the short cut setting screen. Furthermore, for the candidates of the functions displayed, the short cut setting buttons 50, 51, 52, 53, and 54 are respectively displayed. Icons comprised of marks and letters are displayed on the short cut setting buttons 50, 51, 52, 53, and 54.

Note that, the candidates of the functions shown in FIG. 7A, that is, the collision damage mitigation function, the steady speed driving function, the headlight auto turn-on function, and the start delay warning function are just some of the candidates of functions listed on the short cut setting screen. In actual, a far greater number of the candidates of functions are displayed on the short cut setting screen. In this case, in the example shown in FIG. 7A, numerous candidates of functions are displayed over several pages. Further, in the example shown in FIG. 7A, the short cut setting buttons 50, 51, 52, 53, 54 of the candidates of functions which are set on, that is, the candidates of the functions which are activated are rendered on in display, and the short cut setting buttons 50, 51, 52, 53, 54 of the candidates of functions which are set on shine brightly at the short cut setting buttons 50, 51, 52, 53, 54 as a whole or the icon parts. The functions to be assigned to the short cut buttons 35, 36 displayed on the basic screen of the display device 21 can be selected by the user of the vehicle 1 from among the candidates of functions listed on this short cut setting screen.

Further, in the example shown in FIG. 7A, display location selection buttons 55 and 56 for selecting one of the two short cut buttons 35, 36 displayed on the basic screen of the display device 21 to which the function selected by the user of the vehicle 1 should be assigned are displayed on the short cut setting screen. In this case, the display location selection buttons 55 and 56 are provided so that it is understood that the short cut button 35 displayed on the basic screen of the display device 21 corresponds to the display location selection button 55 displayed on the short cut setting screen while the short cut button 36 displayed on the basic screen of the display device 21 corresponds to the display location selection button 56 displayed on the short cut setting screen. In this case, in the example shown in FIG. 7A, the short cut button 35 and the display location selection button 55 are displayed by the same icon while the short cut button 36 and the display location selection button 56 are displayed by the same icon. In this case, if no function is assigned to, for example, the short cut button 35, as will be understood from FIG. 7B, no icon is displayed at the display location selection button 55.

For example, when the user of the vehicle 1 desires to assign the headlight auto turn-on function to the short cut button 35, if the user touches the short cut setting button 52 of the headlight auto turn-on function, then touches the display location selection button 55, then touches the setting button 57, the headlight auto turn-on function is assigned to the short cut button 35. If the headlight auto turn-on function is assigned to the short cut button 35, the display and icon of the function which had been assigned to the short cut button 35 up to then are returned to the short cut setting screen and an icon showing the headlight auto turn-on function is displayed on the short cut button 35. If the headlight auto turn-on function finishes being assigned to the short cut button 35, after that, it becomes possible to switch between the on setting and off setting of the headlight auto turn-on function by just touching the short cut button 35 displayed on the basic screen of the display device 21.

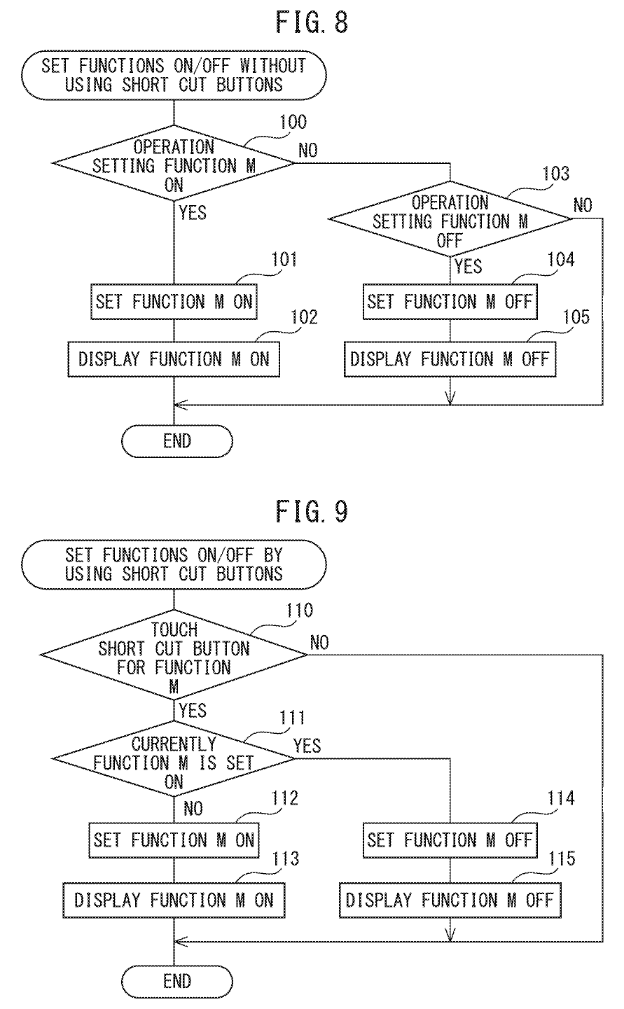

Next, referring to FIG. 8 and FIG. 9, the routine for performing processing for setting functions on/off without using the short cut buttons 35, 36 and the routine for performing processing for setting functions on/off by using the short cut buttons 35, 36 will be successively explained. FIG. 8 shows a flow chart for performing processing for setting functions on/off without using short cut buttons 35, 36, and FIG. 9 shows a flow chart for performing processing for setting functions on/off by using short cut buttons 35, 36. The routines shown in FIG. 8 and FIG. 9 are provided for each function and these routines are repeatedly performed in the electronic control unit 13. Note that, a program for performing each function is stored in advance in the memory 16 of the electronic control unit 13.

Referring to FIG. 8 showing the routine for performing the processing for setting functions on/off without using the short cut buttons 35, 36, first, at step 100, it is judged whether an operation requesting activation of the function M, that is, an operation for setting the function M on has been performed by the user. For example, when the user touches the Japanese food restaurant button 43 in FIG. 5, it is judged that an operation requesting activation of the Japanese food restaurant position display function for displaying positions of Japanese food restaurants on the road map has been performed, that is, an operation for setting the Japanese food restaurant position display function on has been performed. In this case, the function M indicates the Japanese food restaurant position display function. Further, when the user touches the ON button of the headlight auto turn-on function in FIG. 6B, it is judged that an operation requesting activation of the headlight auto turn-on function for making the headlights automatically turn on when the brightness of the surroundings becomes a threshold value or less has been performed, that is, an operation for setting the headlight auto turn-on function on has been performed. In this case, the function M indicates the headlight auto turn-on function.

When, at step 100, it is judged that an operation requesting activation of the function M, that is, an operation for setting the function M on has been performed by the user, the routine proceeds to step 101 where the function M is set on and the function M is activated. At this time, if the function M is the Japanese food restaurant position display function, the Japanese food restaurant position display function for displaying positions of Japanese food restaurants on the road map is performed, while if the function M is the headlight auto turn-on function, the headlight auto turn-on function for making the headlights automatically turn on is performed. If the function M is set on, as shown at step 102, the function M is rendered on in display. At this time, the on/off display switch 46 of the function M shown in FIG. 6B is switched from “display off” to “display on” while the short cut setting button of the candidates of the function M shown in FIG. 7A etc. is switched from “display off” to “display on”. If the short cut button for the function M is being displayed, the short cut button for the function M is switched from an “display off” to “display on”.

As opposed to this, when at step 100, it is judged that an operation requesting activation of the function M, that is, an operation for setting the function M on has not been performed by the user, the routine proceeds to step 103 where it is judged whether an operation for deactivation of the function M, that is, an operation for setting the function M off has been performed by the user. For example, when the positions of Japanese food restaurants are displayed on the road map, if the user touches the button 31 of the navigation function, it is judged that an operation for deactivation of the Japanese food restaurant position display function, that is, an operation for setting the Japanese food restaurant position display function off has been performed. In this case, the “function M” indicates the Japanese food restaurant position display function. Further, when the user touches the OFF button of the headlight auto turn-on function in FIG. 5B, it is judged that an operation for stopping activation of the headlight auto turn-on function has been performed, that is, an operation for setting the headlight auto turn-on function off has been performed. In this case, the “function M” indicates the headlight auto turn-on function.

When at step 103, it is judged that an operation for deactivation of the function M, that is, an operating for setting the function M off has been performed by the user, the routine proceeds to step 104 where the function M is set off and the function M is deactivated. At this time, if the function M is the Japanese food restaurant position display function, display of the positions of Japanese food restaurants on the road map is stopped, and if the function M is the headlight auto turn-on function, the headlight auto turn-on function for making the headlights automatically turn on is deactivated. If the function M is set off, as shown in step 105, the function M is rendered off in display. At this time, the on/off display switch 46 for the function M shown in FIG. 6B is switched from “display on” to “display off” while the short cut setting button of the candidates of the function M shown in FIG. 7A etc. is switched from “display on” to “display off”. If the short cut button for the function M is displayed, the short cut button for the function M is switched from “display on” to “display off”. On the other hand, if, at step 103, it is judged that an operation for setting the function M off has not been performed by the user, the processing cycle is ended.

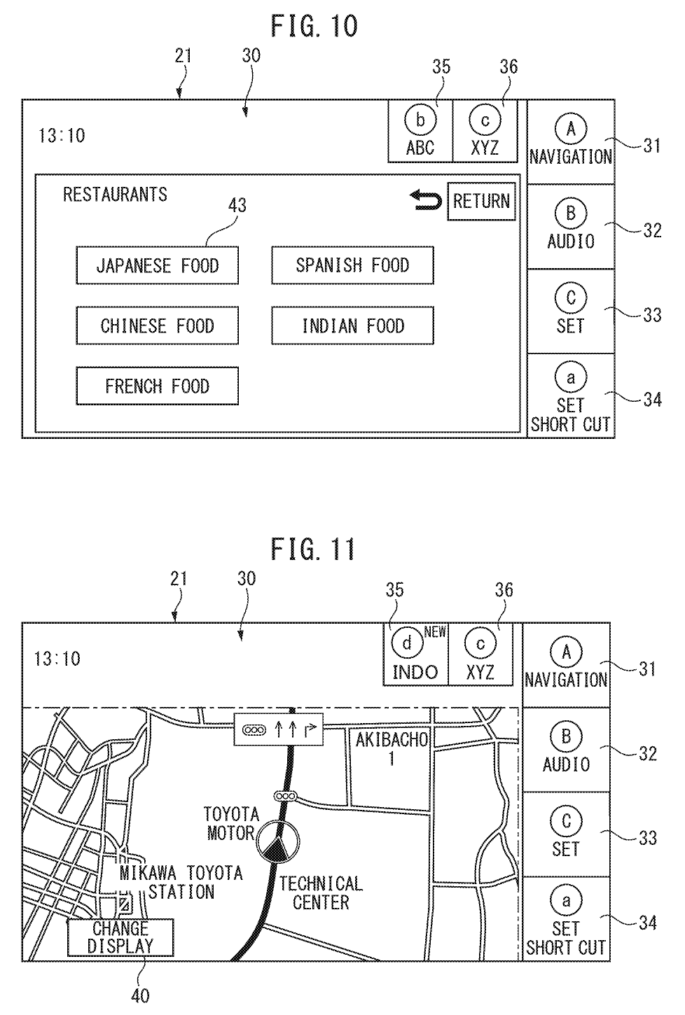

FIG. 9 shows a routine for performing processing for setting functions on/off by using the short cut buttons 35, 36. If explaining FIG. 10 with reference to the example of the case where the function M is assigned to one of the short cut buttons 35, 36, for example, the short cut button 35, first, at step 110, it is judged whether the short cut button 35 to which the function M has been assigned has been touched. When it is judged that the short cut button 35 has been touched, the routine proceeds to step 111 where it is judged whether currently the function M is set on, that is, whether the function M is activated. When it is judged that the function M is set off, that is, when it is judged that function M is deactivated, the routine proceeds to step 112.

At step 112, the function M is set on and the function M is activated. At this time, if the function M is the Japanese food restaurant position display function, the Japanese food restaurant position display function for displaying the positions of Japanese food restaurants on the road map is performed, while in the case where the function M is the headlight auto turn-on function, the headlight auto turn-on function for making the headlights automatically turn on is performed. If the function M is set on, as shown at step 113, the function M is rendered on in display. At this time, the short cut setting button of the candidates for the function M shown in FIG. 7A etc. is switched from “display off” to “display on”, the on/off display switch 46 of the function M shown in FIG. 6B is switched from “display off” to “display on”, and the short cut button 35 is switched from “display off” to “display on”.

On the other hand, when, at step 111, it is judged that the function M is currently set on, that is, the function M is activated, the routine proceeds to step 114 where the function M is set off and the function M is deactivated. At this time, if the function M is the Japanese food restaurant position display function, the display of the positions of Japanese food restaurants on the road map is stopped, while if the function M is the headlight auto turn-on function, the headlight auto turn-on function for making the headlights automatically turn on is deactivated.

If the function M is set off, as shown at step 115, the function M is rendered off in display. At this time, the short cut setting button of the candidates of the function M shown in FIG. 7A etc. is switched from “display on” to “display off”, the on/off display switch 46 of the function M shown in FIG. 6B is switched from “display on” to “display off”, and the short cut button 35 is switched from “display on” to “display off”. On the other hand, when at step 110, it is judged that the short cut button 35 has not been touched, the processing cycle is ended.

In this way, in an embodiment according to the present disclosure, the short cut buttons 35, 36 are displayed on the basic screen of the display device 21, and it is possible to set the functions respectively assigned to the short cut buttons 35, 36 on/off by just touching the short cut buttons 35, 36. Therefore, it is possible to lessen the burden felt by the user when setting the functions on/off. Here, the issue becomes which functions should be assigned to the short cut buttons 35, 36 to enable the burden felt by the user to be more effectively lessened. Therefore, next, the functions desirably assigned to the short cut buttons 35, 36 will be studied.

Now then, assume that, in the past, as shown in FIG. 5, the Japanese food button 43, the Chinese food button, the French food button, and the Spanish food button were displayed on the restaurant selection screen. In this case, for example, if the Japanese food button 43 is touched, the restaurant selection screen is switched to the road map screen shown in FIG. 3A and the positions of Japanese restaurants are displayed on the road map. On the other hand, assume that when in such a state, a position display function newly enabling the display of the positions of Indian restaurants, that is, an Indian restaurant position display function enabling the display of the positions of Indian restaurants on the road map was developed and that, as shown in FIG. 10, a new selection screen in which an Indian food button is displayed in addition to the Japanese food button 43, the Chinese food button, the French food button, and the Spanish food button was prepared.

In this case, in an embodiment according to the present disclosure, information relating to these functions, including the program for performing the Indian restaurant position display function, and information relating to the restaurant selection screen shown in FIG. 10 are, for example, sent from an information center as addition information of the new function or update information of the existing function and the information sent from the information center is received by each vehicle 1. At this time, among the users of the vehicles 1, there will be users desiring to immediately utilize these added new function or updated existing function. For such users, it may be considered desirable that the short cut buttons for these added new function or updated existing function be immediately displayed.

Therefore, in an embodiment according to the present disclosure, when receiving addition information of the new function or update information of the existing function, the added new function or the updated existing function is assigned to either of the short cut buttons 35, 36 and the short cut button 35, 36 to which the added new function or the updated existing function has been assigned is displayed on the basic screen of the display device 21. In this case, the question becomes which one of the short cut buttons 35, 36 the added new function or the updated existing function desirably replaces the function already assigned. Note that when three or more short cut buttons are displayed on the basic screen of the display device 21, the question becomes which of the short cut buttons the added new function or the updated existing function desirably replaces the function already assigned.

In this case, the function originally assigned to the short cut button and replaced with the added new function or the updated existing function is switched from the on/off setting operations of the function by using the short cut button to the on/off setting operations of the function without using the short cut button, so for the user, the on/off settings of the function become burdensome and the degree of burden on the user increases. In this case, at this time, it can be said to be desirable to select the replaced function so that as much as possible the degree of burden placed on the user does not increase. Therefore, in an embodiment of the present disclosure, among the functions assigned to the short cut buttons a short cut button to which is assigned a function not burdening the user the most when performing the on/off setting operations of the function without using the short cut button is selected as the function replacement short cut button.

For example, if assuming that, among the functions assigned to the short cut buttons, the short cut button to which is assigned a function most not burdening the user when performing the on/off setting operations of the function without using the short cut button is the short cut button 35, the short cut button 35 is selected as the function replacement short cut button. In this case, for example, when receiving addition information of the Indian restaurant position display function, that added Indian restaurant position display function is assigned to the short cut button 35 and, as shown in FIG. 11, the short cut button 35 to which is assigned the Indian restaurant position display function is displayed on the basic screen of the display device 21.

On the other hand, for the user, it may be considered desirable that the short cut button be displayed even for a function with a high frequency of performance of the on setting operation or off setting operation of the function without using the short cut button. In this case as well, in an embodiment according to the present disclosure, a short cut button to which is assigned a function most not burdening the user when performing the on/off setting operations of the function without using the short cut button among the functions assigned to the short cut buttons is selected as the function replacement short cut button.

Next, which short cut button is a short cut button to which is assigned a function most not burdening the user when performing the on/off setting operations of the function without using the short cut button among the functions assigned to the short cut buttons, that is, which short cut button should be selected as the function replacement short cut button, will be explained below taking as an example a case where two short cut buttons 35, 36 are displayed on the basic screen of the display device 21. Note that, in the following explanation, either one of the short cut buttons 35, 36 will be referred to as the “short cut button P” and the remaining one of the short cut buttons 35, 36 will be referred to as the “short cut button Q”.

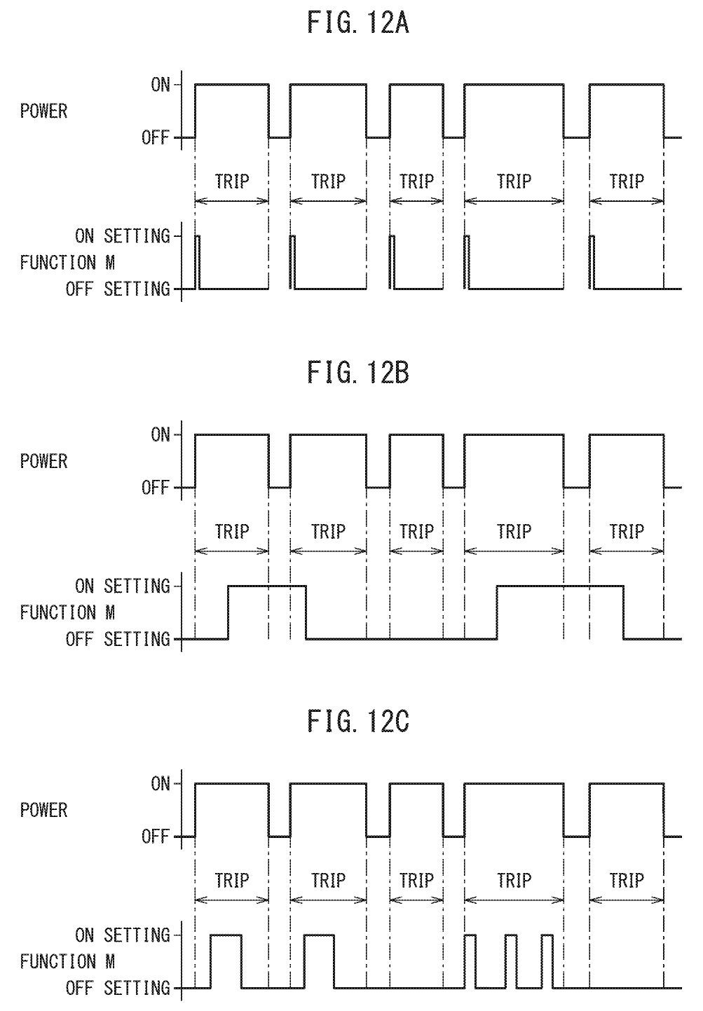

First, referring to FIG. 12A to FIG. 14, the three main factors governing the degree of burden imposed on the user when performing the on/off setting operations of the function without using the short cut button will be explained. FIG. 12A, FIG. 12B, and FIG. 12C show the relationship between the on/off operations of power of the vehicle 1 and the on/off setting operations of the function M. In FIG. 12A, FIG. 12B, and FIG. 12C, the abscissa shows the elapsed time. Note that the functions M in FIG. 12A, FIG. 12B, and FIG. 12C respectively show the collision damage mitigation function, steady speed driving function, headlight auto turn-on function, start delay warning function, Japanese restaurant position display function etc. Further, as shown in FIG. 12A, FIG. 12B, and FIG. 12C, the time period from when the power of the vehicle 1 is turned on to when power of the vehicle 1 is turned off, that is, the time period in which the drive control of the vehicle 1 is possible, will be called a “trip”. In the example shown in FIG. 12A, FIG. 12B, and FIG. 12C, each of “trip” will be called, in order from the left, a first trip, second trip, third trip, fourth trip, and fifth trip.

FIG. 12A shows the case where the function M is set on when the power of the vehicle 1 is turned on and the function M is set off immediately when the function M is set on. For example, FIG. 12A shows the case where the function M is designed to be automatically set on when the power is turned on, but where the user of the vehicle 1 does not want activation of the function M and therefore when the power is turned on and the function M is set on, the function immediately ends up being set off by the user. In this case, as shown in FIG. 12A, in the first to the fifth trips, the function M is always set on, and the probability of the function being set to off is extremely high.

On the other hand, FIG. 12B shows the case where in the first trip, second trip, fourth trip, and fifth trip, the function M is set on or set off, while in the third trip, the function M is not set on/off. On the other hand, FIG. 12C shows the case where in the first trip, second trip, and fourth trip, the function M is set on and set off while in the third trip and fifth trip, the function M is not set on/off. In an embodiment according to the present disclosure, among the plurality of trips, that is, in the example shown in FIG. 12A, FIG. 12B, and FIG. 12C, among the five trips, the number of trips during which the on setting operation or off setting operation of the function was performed is called the ratio X of number of trips during which the on setting operation or off setting operation of the function was performed. In this case, in the example shown in FIG. 12A, FIG. 12B, and FIG. 12C, the ratios X of the number of trips are respectively 1.0, 0.8, and 0.6.

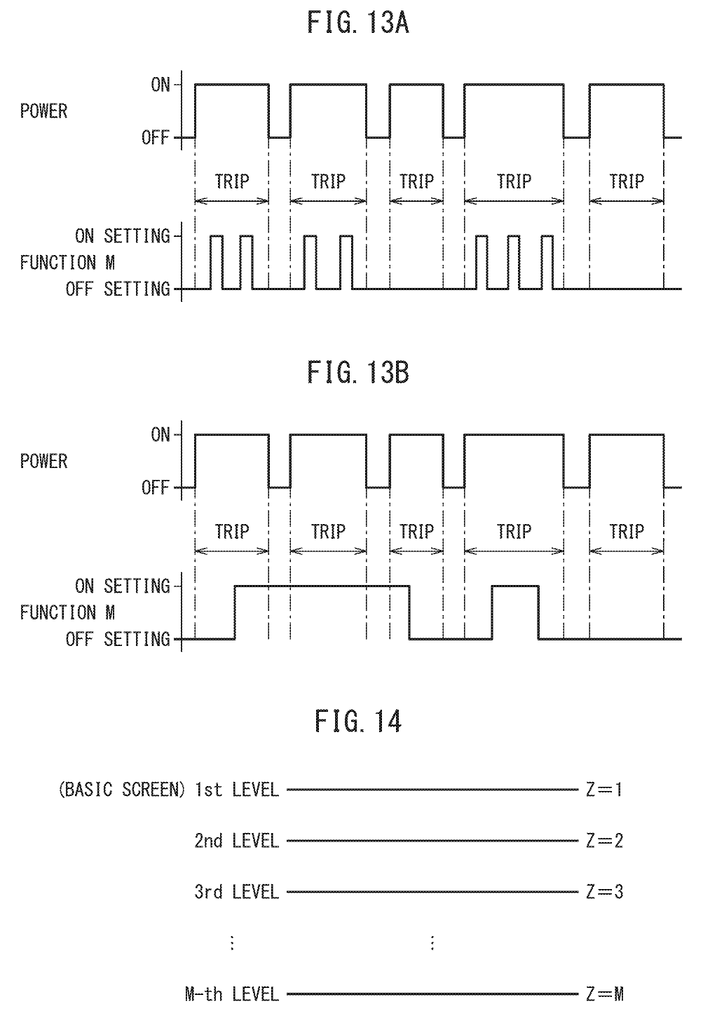

FIG. 13A and FIG. 13B, like FIG. 12A, FIG. 12B, and FIG. 12C, show the relationship of the on/off operations of power of the vehicle 1 and the on/off setting operations of the function M. FIG. 13A and FIG. 13B show the case where the function M has been set on/off multiple times within the five trip periods. In an embodiment according to the present disclosure, the number of the on/off settings of the function M performed in a certain time period will be called the frequency Y of performance of the on setting operation or off setting operation of the function or the frequency Y of performance of the on/off setting operations of the function. In this case, in the examples shown in FIG. 13A and FIG. 13B, the frequencies Y of performance of the on/off setting operations of the function respectively become 14 and 4. In this case, the above set time period can also be made one trip time period.

FIG. 14 is a view schematically showing levels Z at the screen of the display device 21. In FIG. 14, a first level (Z=l) shows the basic screen of the display device 21, a second level (Z=2) shows one level below the basic screen of the display device 21, that is, the first level (Z=l), a third level (Z=3) shows one level below the second level (Z=2), and an M-th level (Z=M) shows a further lower level than the third level (Z=3). In this case, a level near the basic screen of the display device 21 will be referred to as a “shallow level” while a level far from the basic screen of the display device 21 will be referred to as a “deep level”. In an embodiment according to the present disclosure, the on setting screen or off setting screen of the function when performing the on/off setting operations without using the short cut button is displayed on any level from the first level (Z=l) to the M-th level (Z=M).

The three main factors governing the degree of burden placed on the user when performing the on/off setting operations without using the short cut button are the ratio X of number of trips during which the on setting operation or off setting operation of the function was performed, the frequency Y of performance of the on/off setting operations of the function, and the level Z at the screen of the display device 21. In this case, it can be easily understood that the shallower the level at which the on setting screen or off setting screen of the function when performing the on/off setting operations without using the short cut button, the lower the degree of burden placed on the user when performing the on/off setting operations without using the short cut button.

On the other hand, when the level at which the on setting screen or off setting screen of the function is displayed when performing the on/off setting operations without using the short cut button is fixed, the smaller the ratio X of number of trips during which the on setting operation or off setting operation of the function was performed, the lower the degree of burden placed on the user when performing the on/off setting operations without using the short cut button. Further, when the level at which the on setting screen or off setting screen of the function is displayed when performing the on/off setting operations without using the short cut button is fixed, the smaller the frequency Y of performance of the on/off setting operations of the function, the lower the degree of burden placed on the user when performing the on/off setting operations without using the short cut button

In this way, the degree of burden placed on the user when performing the on/off setting operations without using the short cut button is governed by the ratio X of number of trips during which the on setting operation or off setting operation of the function was performed, the frequency Y of performance of the on/off setting operations of the function, and the level Z at the screen of the display device 21. In this case, the relationship of the degree of burden placed on the user when performing the on/off setting operations without using the short cut button and the ratio X of number of trips during which the on setting operation or off setting operation of the function was performed is determined based on results of experiments or rule of thumb, the relationship of the degree of burden placed on the user when performing the on/off setting operations without using the short cut button and the frequency Y of performance of the on/off setting operations of the function is also determined based on results of experiments or rule of thumb, and the relationship of the degree of burden placed on the user when performing the on/off setting operations without using the short cut button and the level Z at the screen of the display device 21 is also determined based on results of experiments or rule of thumb.

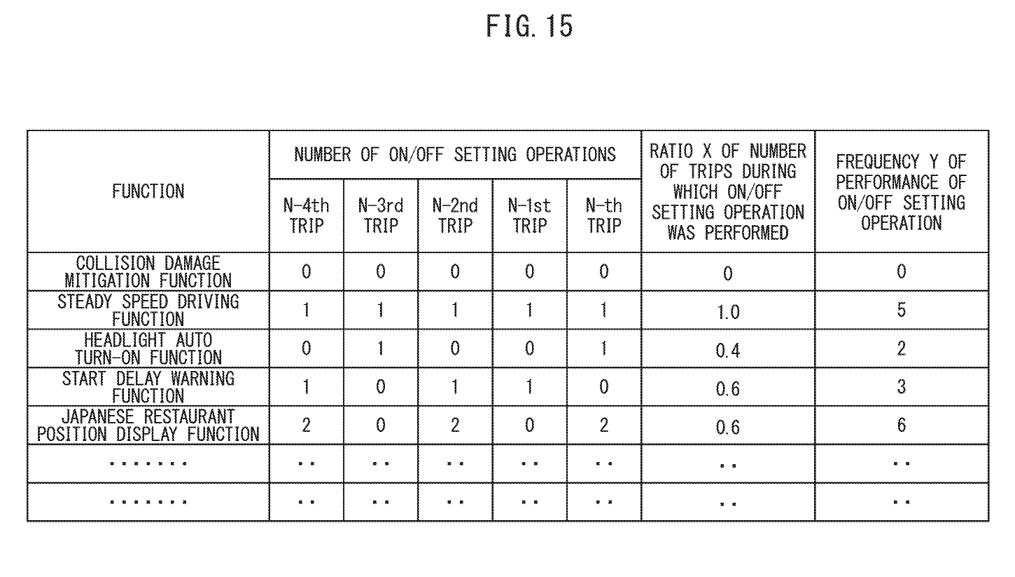

In an embodiment according to the present disclosure, the number of the on setting operation or off setting operation of the function in each trip is continuously stored in the memory 16 of the electronic control unit 13 for each function. Based on the number of the on setting operation or off setting operation of the function in each trip, the ratio X of number of trips during which the on setting operation or off setting operation of the function was performed and the frequency Y of performance of the on/off setting operations of the function are calculated for each function when the power is turned off in the electronic control unit 13. These values are stored in the memory 16 of the electronic control unit 13 in the form of a list of the number of the on/off setting operations such as shown in FIG. 15.

In the list of the number of the on/off setting operations such as shown in FIG. 15, the N-th trip shows the trip right before the power is turned off, the N-1st trip shows the trip before the N-th trip, the N-2nd trip shows the trip before the N-1st trip, the N-3rd trip shows the trip before the N-2nd trip, and the N-4th grip shows the trip before the N-3rd trip. Further, the ratio X of number of trips during which the on setting operation or off setting operation of the function was performed is calculated for each function based on the existence of the any on/off operations of the function performed in the five trips from the N-4th trip to the N-th trip while the frequency Y of performance of the on/off setting operations of the function is also calculated based on the number of performance of the on/off operations of the function in the five trips from the N-4th trip to the N-th trip.

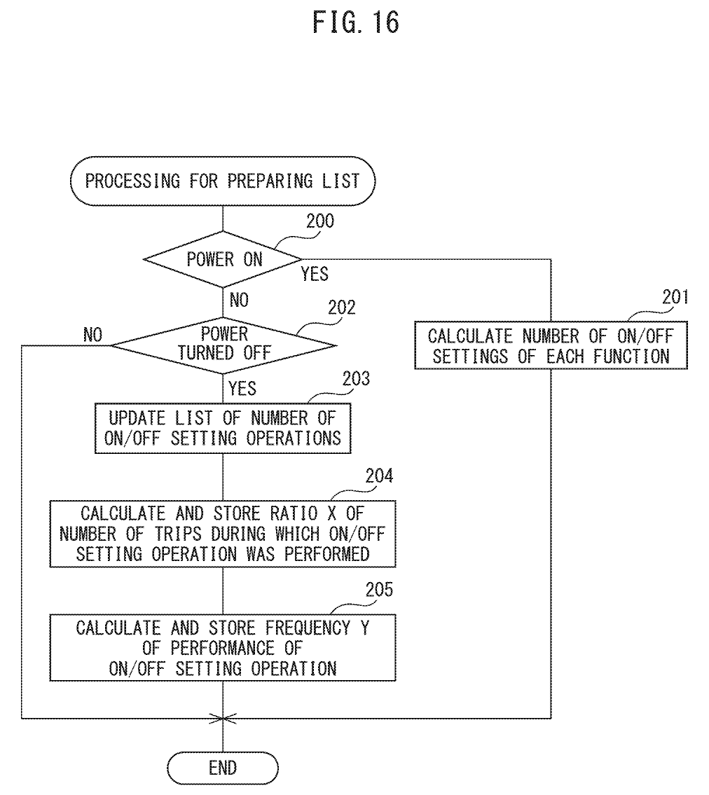

FIG. 16 shows a routine for performing list preparing processing for preparing a list of the number of the on/off setting operations shown in FIG. 15. This routine is repeatedly performed in the electronic control unit 13 of each vehicle 1. Referring to FIG. 16, first, at step 200, it is judged if the power of the vehicle 1 is on. When it is judged that the power of the vehicle 1 is on, the routine proceeds to step 201 where for each function, the total number of the number of times the function was switched from the on setting to the off setting and the number of times the function was switched from the off setting to the on setting after the power of the vehicle 1 was turned on, that is, the number of on/off settings of the function after the power of the vehicle 1 was turned on is calculated. On the other hand, when at step 200 it is judged that the power of the vehicle 1 is off, the routine proceeds to step 202 where it is judged if the power of the vehicle 1 has now been switched from on to off, that is, if the power of the vehicle 1 is turned off. When it is judged that the power of the vehicle 1 is turned off, the routine proceeds to step 203.

At step 203, the list of the number of on/off setting operations shown in FIG. 15 is updated. That is, the number of the on/off setting operations of each function in the N-3rd trip is moved to the N-4th trip, the number of the on/off setting operations of each function in the N-2nd trip is moved to the N-3rd trip, the number of the on/off setting operations of each function in the N-1st trip is moved to the N-2nd trip, and the number of the on/off setting operations of each function in the N-th trip is made the number of the on/off setting operations calculated at step 200. Next, at step 204, the ratio X of number of trips during which the on setting operation or off setting operation of the function was performed is calculated and the results of calculation are stored. Next, at step 205, the frequency Y of performance of the on/off setting operations for each function is calculated and the results of calculation are stored. In this way, the list of the number of the on/off setting operations shown in FIG. 15 is prepared.

On the other hand, in an embodiment according to the present disclosure, as explained above, the on setting screen or off setting screen of the function when performing the on/off setting operations without using the short cut button is displayed at any level of the first level (Z=l) to the M-th level (Z=M) shown in FIG. 14. The level at which the on setting screen or off setting screen of the function when performing the on/off setting operations of the function without using the short cut button is displayed is stored in the memory 16 of the electronic control unit 13. In an embodiment according to the present disclosure, the function replacement short cut button for which a replacement of the function is performed when replacing the function assigned to the short cut button with another function is selected based on the ratio X of number of trips during which the on setting operation or off setting operation of the function was performed and the frequency Y of performance of the on/off setting operations for each function shown in the list of the number of the on/off setting operation etc. and the level at which the on setting screen or off setting screen for each function is displayed and which is stored in the memory 16.

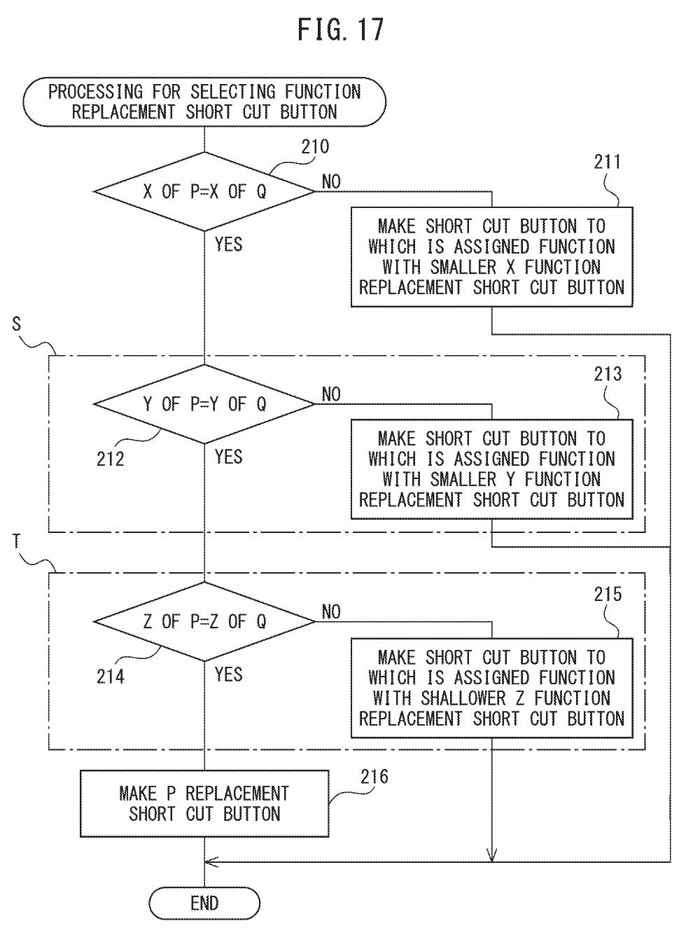

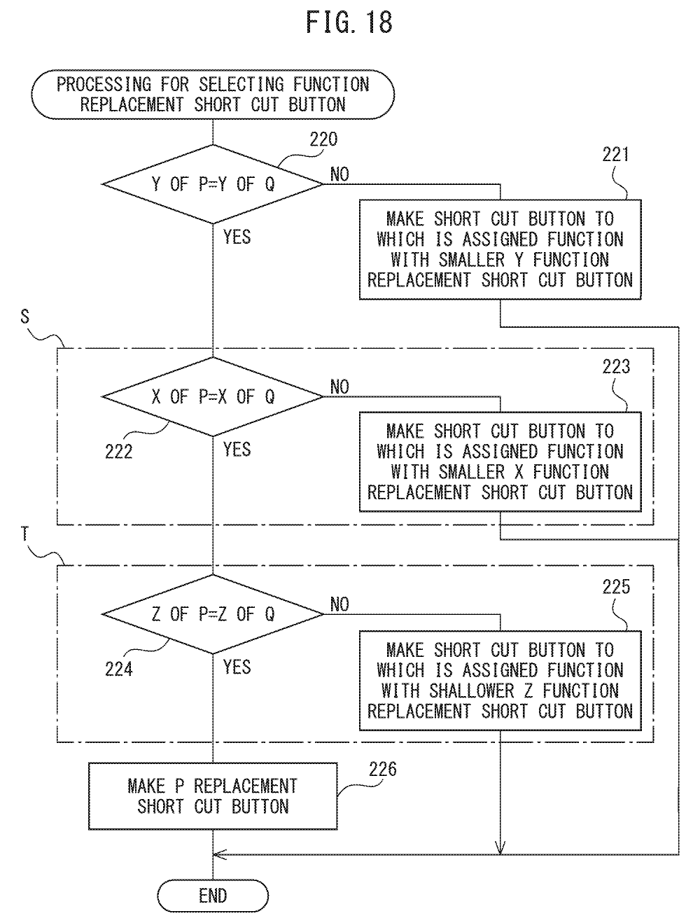

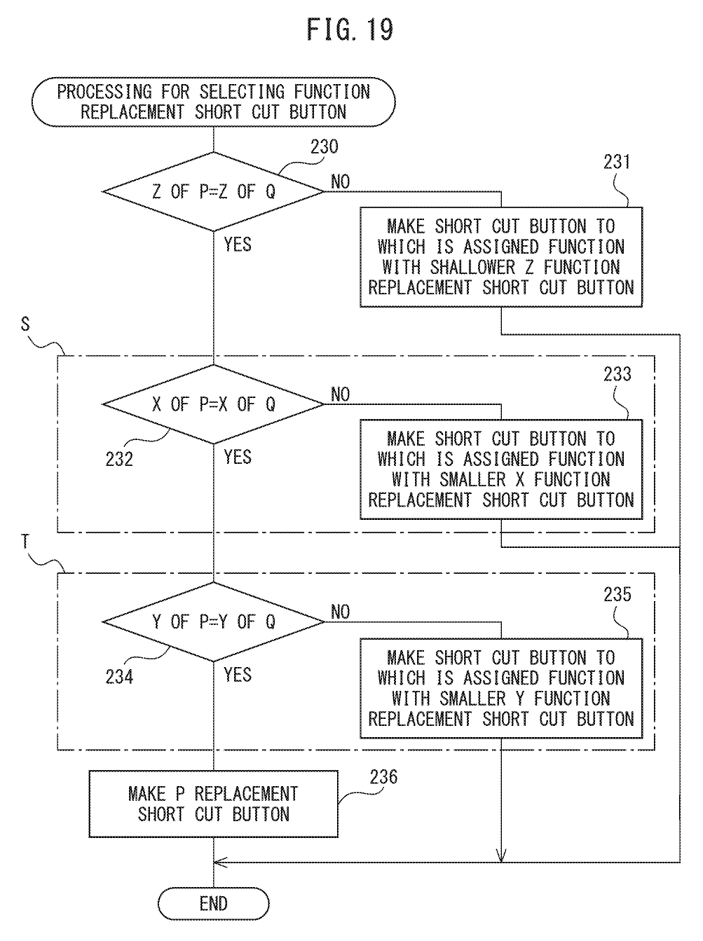

Routines for performing function replacement short cut button selection processing for selecting a function replacement short cut button are shown in FIG. 17, FIG. 18, and FIG. 19. These routines are repeatedly performed in the electronic control unit 13 of each vehicle 1. Note that, in FIG. 17, FIG. 18, and FIG. 19, the X of P and the X of Q are respectively the ratio X of number of trips during which the on setting operation or off setting operation of the function assigned to the short cut button P was performed and the ratio X of number of trips during which the on setting operation or off setting operation of the function assigned to the short cut button Q was performed, the Y of P and the Y of Q are respectively the frequency Y of performance of the on/off setting operations of the function assigned to the short cut button P and the frequency Y of performance of the on/off setting operations of the function assigned to the short cut button Q, and the Z of P and the Z of Q are respectively the level Z at which the on setting screen or off setting screen of the function assigned to the short cut button P is displayed and the level Z at which the on setting screen or off setting screen of the function assigned to the short cut button Q is displayed.

Note that, the terms expressing the X of P, X of Q, Y of P, Y of Q, Z of P, and Z of Q are too long, therefore below, the expressions will be simplified and the X of P and X of Q will respectively be referred to as the ratio X of the number of trips of the function of the short cut button P and the ratio X of the number of trips of the function of the short cut button Q, the Y of P and Y of Q will respectively be referred to as the frequency Y of performance of the setting operations of the function of the short cut button P and the frequency Y of performance of the setting operations of the function of the short cut button Q, and the Z of P and Z of Q will respectively be referred to as the on/off setting screen display level Z of the function of the short cut button P and the on/off setting screen display level Z of the function of the short cut button Q.

First, referring to the routine for selecting the function replacement short cut button shown in FIG. 17, at step 210, it is judged whether the ratio X of the number of trips of the function of the short cut button P and the ratio X of the number of trips of the function of the short cut button Q are equal. When it is judged that the ratio X of the number of trips of the function of the short cut button P and the ratio X of the number of trips of the function of the short cut button Q are not equal, the routine proceeds to step 211 where the short cut button to which is assigned the function with a smaller ratio X of number of trips is made the function replacement short cut button. That is, the short cut button to which is assigned the function with the smallest ratio X of number of trips during which the on setting operation or off setting operation of the function was performed among the functions assigned to the short cut buttons P and Q is selected as the function replacement short cut button. Next, the processing cycle is ended.

On the other hand, when at step 210 it is judged that the ratio X of the number of trips of the function of the short cut button P and the ratio X of the number of trips of the function of the short cut button Q are equal, the routine proceeds to step 212 where it is judged if the frequency Y of performance of the setting operations of the function of the short cut button P and the frequency Y of performance of the setting operations of the function of the short cut button Q are equal. When it is judged that the frequency Y of performance of the setting operations of the function of the short cut button P and the frequency Y of performance of the setting operations of the function of the short cut button Q are not equal, the routine proceeds to step 213 where the short cut button to which is assigned the function with the smaller frequency Y of performance of the setting operations of the function is made the function replacement short cut button. That is, the short cut button to which is assigned the function with the smallest frequency Y of performance of the on setting operation or off setting operation of the function among the functions assigned to the short cut buttons P and Q is selected as the function replacement short cut button. Next, the processing cycle is ended.

On the other hand, when at step 212 it is judged if the frequency Y of performance of the setting operations of the function of the short cut button P and the frequency Y of performance of the setting operations of the function of the short cut button Q are equal, the routine proceeds to step 214, where it is judged whether the on/off setting screen display level Z of the function of the short cut button P and the on/off setting screen display level Z of the function of the short cut button Q are equal. When it is judged that the on/off setting screen display level Z of the function of the short cut button P and the on/off setting screen display level Z of the function of the short cut button Q are not equal, the routine proceeds to step 215 where the short cut button to which is assigned the function with a shallower on/off setting screen display level Z is made the function replacement short cut button. That is, the short cut button to which is assigned the function with the on setting screen or off setting screen of the function displayed at the shallowest level from the basic screen 21 when performing the on/off setting operations of the function without using the short cut button among the functions assigned to the short cut buttons P, Q is selected as the function replacement short cut button. Next, the processing cycle is ended.

On the other hand, when at step 214 it is judged that the on/off setting screen display level Z of the function of the short cut button P and the on/off setting screen display level Z of the function of the short cut button Q are equal, the routine proceeds to step 216 where a predetermined one short cut button among the short cut button P and short cut button Q, for example, the short cut button P, is selected as the function replacement short cut button. Next, the processing cycle is ended. Note that, in the routine shown in FIG. 17, it is possible to exchange the routine part S comprised of two steps and the routine part T comprised of two steps.

Next, referring to the routine for processing for selecting the function replacement short cut button shown in FIG. 18, at step 220, it is judged if the frequency Y of performance of the setting operations of the function of the short cut button P and the frequency Y of performance of the setting operations of the function of the short cut button Q are equal. When it is judged that the frequency Y of performance of the setting operations of the function of the short cut button P and the frequency Y of performance of the setting operations of the function of the short cut button Q are not equal, the routine proceeds to step 221 where the short cut button to which is assigned the function with a smaller frequency Y of performance of the setting operations of the function is made the function replacement short cut button. That is, the short cut button to which is assigned the function with the smallest frequency Y of performance of the on setting operation or off setting operation of the function among the functions assigned to the short cut buttons P, Q is selected as the function replacement short cut button. Next, the processing cycle is ended.

On the other hand, when at step 220 it is judged that the frequency Y of performance of the setting operations of the function of the short cut button P and the frequency Y of performance of the setting operations of the function of the short cut button Q are equal, the routine proceeds to step 222 where it is judged if the ratio X of the number of trips of the function of the short cut button P and the ratio X of the number of trips of the function of the short cut button Q are equal. When it is judged that the ratio X of the number of trips of the function of the short cut button P and the ratio X of the number of trips of the function of the short cut button Q are not equal, the routine proceeds to step 223 where the short cut button to which is assigned the function with the smaller ratio X of number of trips is made the function replacement short cut button. That is, the short cut button to which is assigned the function with the smallest ratio X of number of trips during which the on setting operation or off setting operation of the function was performed among the functions assigned to the short cut buttons P, Q is selected as the function replacement short cut button. Next, the processing cycle is ended.

On the other hand, when at step 222 it is judged that the ratio X of the number of trips of the function of the short cut button P and the ratio X of the number of trips of the function of the short cut button Q are equal, the routine proceeds to step 224 where it is judged if the on/off setting screen display level Z of the function of the short cut button P and the on/off setting screen display level Z of the function of the short cut button Q are equal. When it is judged that the on/off setting screen display level Z of the function of the short cut button P and the on/off setting screen display level Z of the function of the short cut button Q are not equal, the routine proceed to step 225 where the short cut button to which is assigned the function with the shallower on/off setting screen display level Z is made the function replacement short cut button. That is, the short cut button to which is assigned the function with the on setting screen or off setting screen of the function displayed at the shallowest level from the basic screen 21 when performing the on/off setting operations of the function without using the short cut button function among the functions assigned to the short cut buttons P, Q is selected as the function replacement short cut button. Next, the processing cycle is ended.

On the other hand, when at step 224 it is judged that the on/off setting screen display level Zof the function of the short cut button P and the on/off setting screen display level Z of the function of the short cut button Q are equal, the routine proceeds to step 226 where a predetermined one short cut button among the short cut button P and short cut button Q, for example, the short cut button P, is selected as the function replacement short cut button. Next, the processing cycle is ended. Note that, in the routine shown in FIG. 18, it is possible to exchange the routine part S comprised of two steps and the routine part T comprised of two steps.

Next, referring to the routine for processing for selecting the function replacement short cut button shown in FIG. 19, at step 230, it is judged if the on/off setting screen display level Z of the function of the short cut button P and the on/off setting screen display level Z of the function of the short cut button Q are equal. When it is judged that the on/off setting screen display level Z of the function of the short cut button P and the on/off setting screen display level Z of the function of the short cut button Q are not equal, the routine proceeds to step 231 where the short cut button to which is assigned the function with the shallower on/off setting screen display level Z is made the function replacement short cut button. That is, the short cut button to which is assigned the function with the on setting screen or off setting screen of the function displayed at the shallowest level from the basic screen 21 when performing the on/off setting operations of the function without using the short cut button function among the functions assigned to the short cut buttons P, Q is selected as the function replacement short cut button. Next, the processing cycle is ended.

On the other hand, when, at step 230, it is judged that the on/off setting screen display level Z of the function of the short cut button P and the on/off setting screen display level Z of the function of the short cut button Q are equal, the routine proceeds to step 232 where it is judged whether the ratio X of the number of trips of the function of the short cut button P and the ratio X of the number of trips of the function of the short cut button Q are equal. When it is judged that the ratio X of the number of trips of the function of the short cut button P and the ratio X of the number of trips of the function of the short cut button Q are not equal, the routine proceeds to step 233 where the short cut button to which is assigned the function with the smaller ratio X of the number of trips is made the function replacement short cut button. That is, the short cut button to which is assigned the function with the smallest ratio X of number of trips during which the on setting operation or off setting operation of the function was performed among the functions assigned to the short cut buttons P, Q is selected as the function replacement short cut button. Next, the processing cycle is ended.

On the other hand, when at step 232 it is judged that the ratio X of the number of trips of the function of the short cut button P and the ratio X of the number of trips of the function of the short cut button Q are equal, the routine proceeds to step 234 where it is judged whether the frequency Y of performance of the setting operations of the function of the short cut button P and the frequency Y of performance of the setting operations of the function of the short cut button Q are equal. When it is judged that the frequency Y of performance of the setting operations of the function of the short cut button P and the frequency Y of performance of the setting operations of the function of the short cut button Q are not equal, the routine proceeds to step 235 where the short cut button to which is assigned the function with the smaller frequency Y of performance of the setting operations of the function is made the function replacement short cut button. That is, the short cut button to which is assigned the function with the smallest frequency Y of performance of the on setting operation or off setting operation of the function among the functions assigned to the short cut buttons P, Q is selected as the function replacement short cut button. Next, the processing cycle is ended.

On the other hand, when at step 234 it is judged that the frequency Y of performance of the setting operations of the function of the short cut button P and the frequency Y of performance of the setting operations of the function of the short cut button Q are equal, the routine proceeds to step 236 where a predetermined one short cut button among the short cut button P and short cut button Q, for example, the short cut button P, is selected as the function replacement short cut button. Next, the processing cycle is ended. Note that, in the routine shown in FIG. 19, it is possible to exchange the routine part S comprised of two steps and the routine part T comprised of two steps.

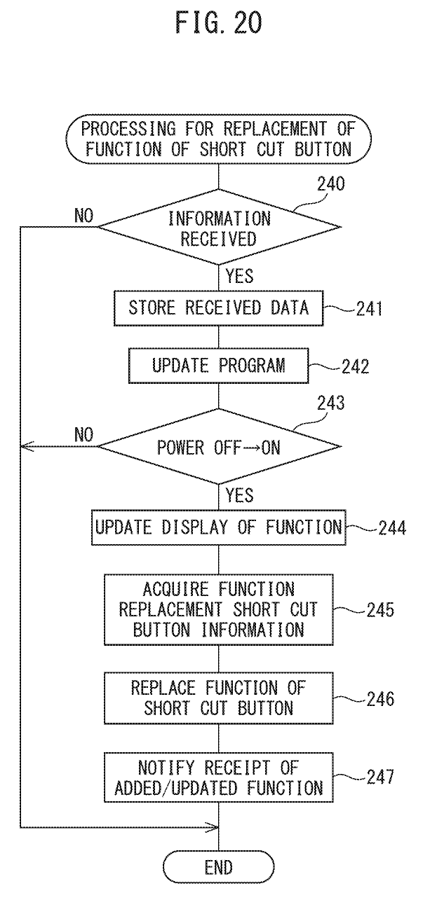

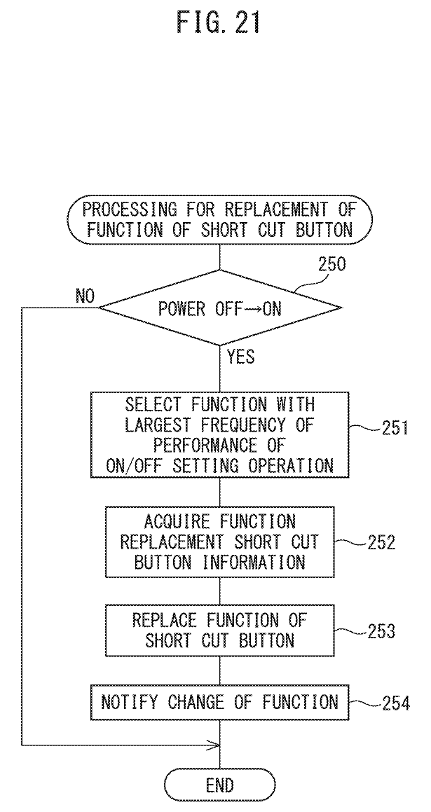

FIG. 20 and FIG. 21 respective show routines for using information of the function replacement short cut button selected by any of the routines shown in FIG. 17, FIG. 18, and FIG. 19 to perform processing for replacement of functions of the short cut buttons. These routines are repeatedly performed in the electronic control unit 13 of each vehicle 1.

Referring to FIG. 20, first, at step 240, it is judged if addition information of the new function or update information of the existing function has been received from the information center. When it is judged that such information has not been received, the processing cycle is ended. As opposed to this, when it is judged that such information has been received, the routine proceeds to step 241 where the received data relating to the information is stored in the memory 16 in the electronic control unit 13. Next, at step 242, based on the received data, the program stored in the memory 16 is updated. Next, at step 243, it is judged whether the power of the vehicle 1 has been switched from off to on, that is, whether the power is turned on. When it is judged that the power is not turned on, the processing cycle is ended.

As opposed to this, when at step 243 it is judged that the power is turned on, the routine proceeds to step 244 where the display of the functions is updated. For example, the restaurant selection screen is changed from the restaurant selection screen shown in FIG. 5 to the restaurant selection screen shown in FIG. 10. Next, at step 245, information of the function replacement short cut button selected by any of the routines of FIG. 17, FIG. 18, and FIG. 19 is acquired. Next, at step 246, the function assigned to the selected function replacement short cut button is replaced by the added new function or the updated existing function. For example, if the selected function replacement short cut button is the short cut button 35, the added new function or updated existing function is assigned to the short cut button 35. In this case, for example, when receiving addition information of the Indian restaurant position display function, that added Indian restaurant display function is assigned to the short cut button 35 and, as shown in FIG. 11, the short cut button 35 to which the Indian restaurant display function has been assigned is displayed on the basic screen of the display device 21. Next, at step 247, the user of the vehicle 1 is notified of the fact that the added/updated function has been received. This notification is performed by displaying the fact of reception of the added/updated function on the basic screen of the display device 21 when the power is turned on.

On the other hand, referring to FIG. 21, first, at step 250, it is judged whether the power of the vehicle 1 has been switched from off to on, that is, whether the power is turned on. If it is judged that the power is not turned on, the processing cycle ends. As opposed to this, if it is judged at step 250 that the power is turned on, the routine proceeds to step 251 where the function with the maximum frequency Y of performance of the on/off setting operations in all functions is selected from the list of the number of the on/off operations shown in FIG. 15. Next, at step 252, information of the function replacement short cut button selected by any of the routines shown in FIG. 17, FIG. 18, and FIG. 19 is acquired. Next, at step 253, the function assigned to the selected function replacement short cut button is replaced by the function with the maximum frequency Y of performance of the on/off setting operations among all functions. For example, if the selected function replacement short cut button was the short cut button 35, the function with the maximum frequency Y of performance of the on/off operations among all functions is assigned to the short cut button 35. Next, at step 254, the user of the vehicle 1 is notified of the change of the function assigned to the short cut button 35.

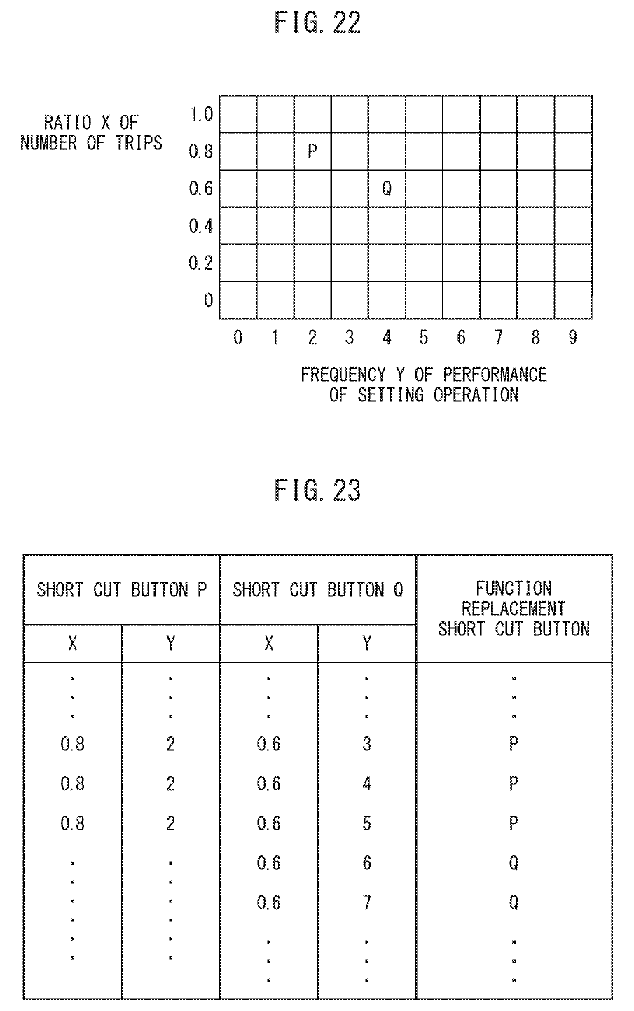

Next, referring to FIG. 22 to FIG. 28, an embodiment configured to select the function replacement short cut button based on at least two of the ratios X of number of trips of the functions of the short cut buttons P, Q, the frequencies Y of performance of the setting operations of the functions of the short cut buttons P, Q, and the on/off setting screen display level Z of the function of Q. First, referring to FIG. 22 and FIG. 23, an embodiment configured to select the function replacement short cut button based on the ratios X of number of trips of the functions of the short cut buttons P, Q and the frequencies Y of performance of the setting operations of the function of the short cut buttons P, Q will be explained.

In this embodiment, for each of the different combinations of the ratio X of number of trips of the function of the short cut button P, the frequency Y of performance of the setting operations of the function of the short cut button P, the ratio X of number of trips of the function of the short cut button Q, and the frequency Y of performance of the setting operations of the function of the short cut button Q (square frames of FIG. 22), which of the short cut buttons P, Q should be selected as the function replacement short cut button so as to minimize the degree of burden placed on the user when performing the on/off setting operations of the function without using the short cut button is determined based on results of experiments and rule of thumb. A list of the short cut buttons to be selected for the function replacement short cut button such as shown in FIG. 23 is stored in the memory 16 of the electronic control unit 13.

For example, if, as shown in FIG. 22, the ratio X of number of trips of the function of the short cut button P is 0.8, the frequency Y of performance of setting operations of the function of the short cut button P is 2, the ratio X of number of trips of the function of the short cut button Q is 0.6 and the frequency Y of performance of setting operations of the function of the short cut button Q is 4, as shown in FIG. 23, the short cut button P is selected as the function replacement short cut button. In this embodiment, the function replacement short cut button is selected based on the list of short cut buttons shown in FIG. 23.

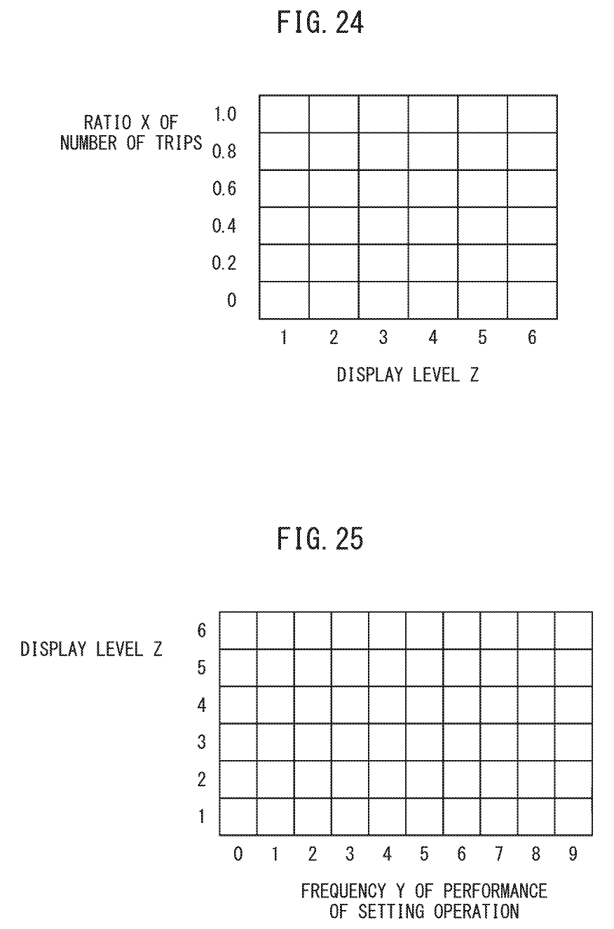

On the other hand, FIG. 24 shows an embodiment configured to select the function replacement short cut button based on the ratios X of the number of trips of the functions of the short cut buttons P, Q and the on/off setting screen display levels Z of the functions of the short cut buttons P, Q. In this embodiment, for each of the different combinations of the ratio X of number of trips of the function of the short cut button P, the on/off setting screen display level Z of the function of the short cut button P, the ratio X of number of trips of the function of the short cut button Q, and the on/off setting screen display level Z of the function of the short cut button Q (square frames of FIG. 24), a list similar to the list of the short cut buttons to be selected for the function replacement short cut button such as shown in FIG. 23 is stored in the memory 16 of the electronic control unit 13. The function replacement short cut button is selected based on this list.

On the other hand, FIG. 25 shows an embodiment configured to select the function replacement short cut button based on the on/off setting screen display levels Z of the functions of the short cut buttons P, Q and the frequencies Y of performance of the setting operations of the functions of the short cut buttons P, Q. In this embodiment, for each of the combination of the on/off setting screen display level Z of the function of the short cut button P, the frequency Y of performance of the setting operations of the function of the short cut button P, the on/off setting screen display level Z of the function of the short cut button Q, and the frequency Y of performance of the setting operations of the function of the short cut button Q (square frames of FIG. 25), a list similar to the list of the short cut buttons to be selected for the function replacement short cut button such as shown in FIG. 23 is stored in the memory 16 of the electronic control unit 13. The function replacement short cut button is selected based on this list.

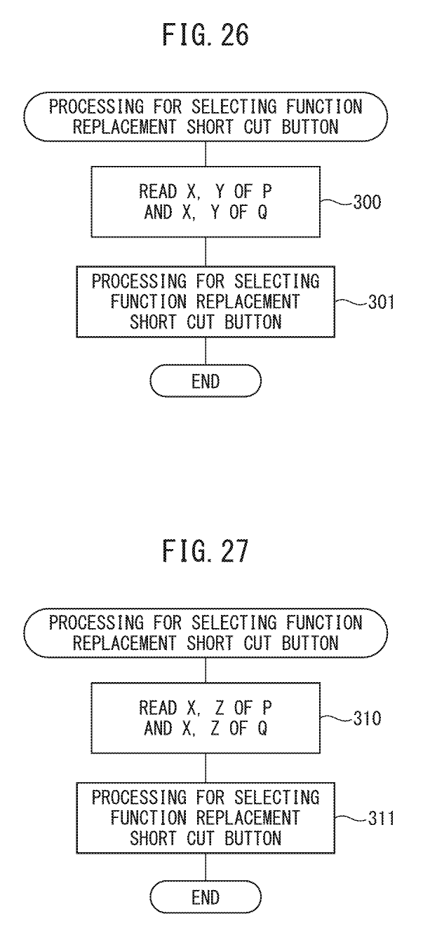

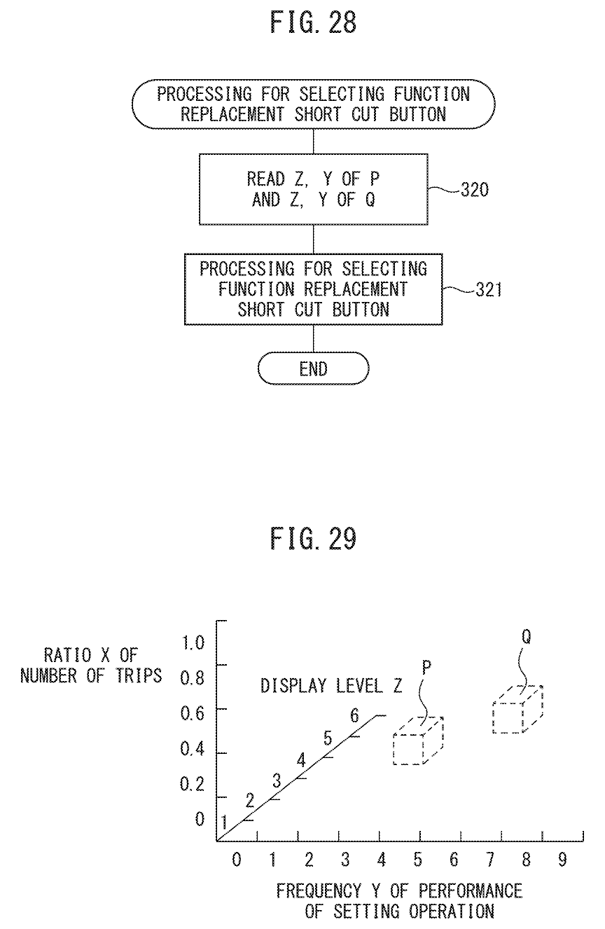

FIG. 26 shows a routine for performing the processing for selecting the function replacement short cut button in the embodiment shown in FIG. 22 and FIG. 23, FIG. 27 shows a routine for performing the processing for selecting the function replacement short cut button in the embodiment shown in FIG. 24, and FIG. 28 shows a routine for performing the processing for selecting the function replacement short cut button in the embodiment shown in FIG. 25. These routines are performed in the electronic control unit 13 of each vehicle 1.

Referring to FIG. 26 showing the routine for performing processing for selecting the function replacement short cut button in the embodiment shown in FIG. 22 and FIG. 23, first, at step 300, the ratio X of the number of trips of the function of the short cut button P, the frequency Y of performance of the setting operations of the function of the short cut button P, the ratio X of the number of trips of the function of the short cut button Q, and the frequency Y of performance of the setting operations of the function of the short cut button Q are read from the list of the number of the on/off settings such as shown in FIG. 15. Next, at step 301, the function replacement short cut button is selected based on the list of short cut buttons shown in FIG. 23.

Next, referring to FIG. 27 showing the routine for performing processing for selecting the function replacement short cut button in the embodiment shown in FIG. 24, first, at step 310, the ratio X of the number of trips of the function of the short cut button P and the ratio X of the number of trips of the function of the short cut button Q are read from the list of the number of the on/off setting operations shown in FIG. 15 and the on/off setting screen display level Z of the function of the short cut button P and the on/off setting screen display level Z of the function of the short cut button Q stored in the memory 16 in the electronic control unit 13 are read. Next, at step 311, the function replacement short cut button is selected based on a list similar to the list of short cut buttons shown in FIG. 23.

Referring to FIG. 28 showing the routine for performing processing for selecting the function replacement short cut button in the embodiment shown in FIG. 25, first, at step 320, the on/off setting screen display level Z of the function of the short cut button P and the on/off setting screen display level Z of the function of the short cut button Q stored in the memory 16 of the electronic control unit 13 are read and the frequency Y of performance of the setting operations of the function of the short cut button P and the frequency Y of performance of the setting operations of the function of the short cut button Q are read from the list of the number of the on/off settings such as shown in FIG. 15. Next, at step 321, the function replacement short cut button is selected based on a list similar to the list of short cut buttons shown in FIG. 23.

If the function replacement short cut button is selected at any of the routines shown in FIG. 26, FIG. 27, and FIG. 28, the information of the selected function replacement short cut button is used to replace the function of the short cut button by the routine for performing a processing for replacement of functions of the short cut buttons shown in FIG. 20 and FIG. 21.

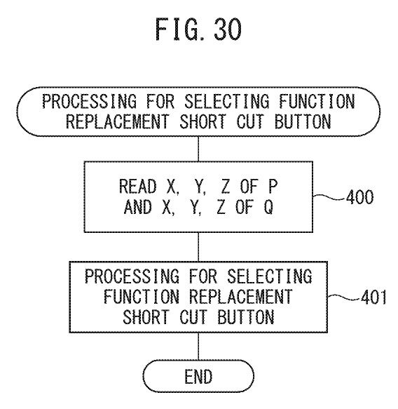

Next, referring to FIG. 29 and FIG. 30, an embodiment configured to select the function replacement short cut button based on the ratios X of numbers of trips of the functions of the short cut buttons P, Q, the frequencies Y of performance of the setting operations of the functions of the short cut buttons P, Q, and the on/off setting screen display levels Z of the functions of the short cut buttons P, Q will be explained.

In this embodiment, for each of the combinations of the ratio X of the number of trips of the function of the short cut button P, the frequency Y of performance of the setting operations of the function of the short cut button P, the on/off setting screen display level Z of the function of the short cut button P, the ratio X of the number of trips of the function of the short cut button Q, the frequency Y of performance of the setting operations of the function of the short cut button Q, and the on/off setting screen display level Z of the function of the short cut button Q (square frames of FIG. 29), which of the short cut buttons P, Q should be selected as the function replacement short cut button so as to minimize the degree of burden placed on the user when performing the on/off setting operations of the function without using the short cut button is determined based on results of experiments and rule of thumb. A list of the short cut buttons to be selected for the function replacement short cut button is stored in the memory 16 of the electronic control unit 13. This list of the short cut buttons is formed in a shape such that, in the list shown in FIG. 23, an on/off setting screen display level Z column is added to the X column and Y column of the short cut button P and an on/off setting screen display level Z column is added to the X column and Y column of the short cut button Q. In this embodiment, the function replacement short cut button is selected based on this list of short cut buttons having X column, Y column, and Z column.

FIG. 30 shows a routine for performing processing for selecting the function replacement short cut button. This routine is performed in the electronic control unit 13 of each vehicle 1. Referring to FIG. 30, first, at step 400, the ratio X of the number of trips of the function of the short cut button P, the frequency Y of performance of the setting operations of the function of the short cut button P, the ratio X of the number of trips of the function of the short cut button Q, and the frequency Y of performance of the setting operations of the function of the short cut button Q are read from the list of the number of on/off settings such as shown in FIG. 15 and the on/off setting screen display level Z of the function of the short cut button P and the on/off setting screen display level Z of the function of the short cut button Q stored in the memory 16 in the electronic control unit 13 are read. Next, step 401, the function replacement short cut button is selected based on the list of short cut buttons having the X column, Y column, and Z column. If the function replacement short cut button is selected, the information of the selected function replacement short cut button is used to replace the function of the short cut function by the routine for performing a processing for replacement of functions of the short cut buttons shown in FIG. 20 and FIG. 21.

In this way, in an embodiment according to the present disclosure, a display control device for controlling the screen display of the display device 21 mounted in the vehicle 1 comprises a short cut button display control unit for making a plurality of short cut buttons 35, 36 be displayed on the basic screen of the display device 21, and a function replacement short cut button selection unit for selecting from among a plurality of the short cut buttons 35, 36 displayed on the basic screen of the display device 21 a function replacement short cut button for which a replacement of the function is performed when replacing the function assigned to the short cut button 35, 36 with another function. The function replacement short cut button selection unit selects as the function replacement short cut button a short cut button to which is assigned a function not burdening a user the most when performing the on/off setting operations of the function without using the short cut button among the functions assigned to the short cut buttons 35, 36.

Further, in an embodiment according to the present disclosure, in a display control method for controlling the screen display of the display device 21 mounted in the vehicle 1, the display control method causes a computer to make a plurality of short cut buttons 35, 36 be displayed on the basic screen of the display device 21, select from among a plurality of the short cut buttons 35, 36 displayed on the basic screen of the display device 21 a function replacement short cut button for which a replacement of the function is performed when replacing the function assigned to the short cut button 35, 36 with another function and at that time select as the function replacement short cut button a short cut button to which is assigned a function not burdening a user the most when performing the on/off setting operations of the function without using the short cut button among the functions assigned to the short cut buttons 35, 36.

Further, in an embodiment according to the present disclosure, there is provided a program or a program product used for controlling the screen display of the display device 21 mounted in the vehicle 1, the program or the program product causing a computer to make a plurality of short cut buttons 35, 36 be displayed on the basic screen of the display device 21, select from among a plurality of the short cut buttons 35, 36 displayed on the basic screen of the display device 21 a function replacement short cut button for which a replacement of the function is performed when replacing the function assigned to the short cut button 35, 36 with another function and at that time select as the function replacement short cut button a short cut button to which is assigned a function not burdening a user the most when performing the on/off setting operations of the function without using the short cut button among the functions assigned to the short cut buttons 35, 36.

Further, in an embodiment according to the present disclosure, the function replacement short cut button selection unit selects as the function replacement short cut button a short cut button to which is assigned the function with the smallest ratio of number of trips during which the on setting operation or off setting operation of the function was performed from among the functions assigned to the short cut buttons 35, 36 based on the state of performance of the on setting operation or off setting operation of functions at each trip of a plurality of trips. Further, in an embodiment according to the present disclosure, the function replacement short cut button selection unit selects as the function replacement short cut button a short cut button to which is assigned the function with the smallest frequency of performance of the on setting operation or off setting operation of the function from among the functions assigned to the short cut buttons 35, 36 based on the state of performance of the on setting operations or off setting operations of the functions. Further, in an embodiment according to the present disclosure, the function replacement short cut button selection unit selects as the function replacement short cut button a short cut button to which is assigned the function where the on setting screen or off setting screen of the function is displayed at the shallowest level from the basic screen from among the functions assigned to the short cut buttons 35, 36 when performing the on/off setting operations of the function without using the short cut button.

Further, in an embodiment according to the present disclosure, the function replacement short cut button selection unit selects the function replacement short cut button based on at least two of a ratio of the number of trips during which the on setting operation or off setting operation of the function assigned to the short cut button 35, 36 was performed, a frequency of performance of the on setting operation or off setting operations of the functions assigned to the short cut buttons 35, 36, and a depth of the level of the on setting screen or off setting screen of the function from the basic screen when performing the on/off setting operations of the function without using the short cut button.

1. A display control device for controlling a screen display of a display device mounted in a vehicle, the display control device comprising
a short cut button display control unit for making a plurality of short cut buttons be displayed on a basic screen of the display device and
a function replacement short cut button selection unit for selecting from among a plurality of the short cut buttons displayed on the basic screen of the display device a function replacement short cut button for which a replacement of the function is performed when replacing the function assigned to the short cut button with another function,
the function replacement short cut button selection unit selecting as the function replacement short cut button a short cut button to which is assigned a function not burdening a user the most when performing on/off setting operations of the function without using the short cut button among the functions assigned to the short cut buttons.

2. The display control device according to claim 1, wherein the function replacement short cut button selection unit selects as the function replacement short cut button a short cut button to which is assigned the function with the smallest ratio of number of trips during which the on setting operation or off setting operation of the function was performed from among the functions assigned to the short cut buttons based on the state of performance of the on setting operation or off setting operation of functions at each trip of a plurality of trips.

3. The display control device according to claim 1, wherein the function replacement short cut button selection unit selects as the function replacement short cut button a short cut button to which is assigned the function with the smallest frequency of performance of the on setting operation or off setting operation of the function from among the functions assigned to the short cut buttons based on the state of performance of the on setting operations or off setting operations of the functions.

4. The display control device according to claim 1, wherein the function replacement short cut button selection unit selects as the function replacement short cut button a short cut button to which is assigned the function where the on setting screen or off setting screen of the function is displayed at the shallowest level from the basic screen from among the functions assigned to the short cut buttons when performing the on/off setting operations of the function without using the short cut button.

5. The display control device according to claim 1, wherein the function replacement short cut button selection unit selects the function replacement short cut button based on at least two of a ratio of the number of trips during which the on setting operation or off setting operation of the function assigned to the short cut button was performed, a frequency of performance of the on setting operation or off setting operations of the functions assigned to the short cut buttons, and a depth of the level of the on setting screen or off setting screen of the function from the basic screen when performing the on/off setting operations of the function without using the short cut button.

6. The display control device according to claim 1, wherein the other function is an added new function or updated existing function.

7. The display control device according to claim 1, wherein the other function is a function with a higher frequency of use than a predetermined frequency of use.

8. The display control device according to claim 1, wherein the short cut button is formed so that the function assigned to the short cut button is switched between an on setting and off setting each time the short cut button is touched.

9. A display control method for controlling a screen display of a display device mounted in a vehicle, the display control method causing a computer to
make a plurality of short cut buttons be displayed on a basic screen of the display device and
select from among a plurality of the short cut buttons displayed on the basic screen of the display device a function replacement short cut button for which a replacement of the function is performed when replacing the function assigned to the short cut button with another function and at that time select as the function replacement short cut button a short cut button to which is assigned a function not burdening a user the most when performing on/off setting operations of the function without using the short cut button among the functions assigned to the short cut buttons.

10. A non-transitory computer-readable storage medium storing a program used for controlling a screen display of a display device mounted in a vehicle, the program causing a computer to
make a plurality of short cut buttons be displayed on a basic screen of the display device and
select from among a plurality of the short cut buttons displayed on the basic screen of the display device a function replacement short cut button for which a replacement of the function is performed when replacing the function assigned to the short cut button with another function and at that time select as the function replacement short cut button a short cut button to which is assigned a function not burdening a user the most when performing on/off setting operations of the function without using the short cut button among the functions assigned to the short cut buttons.
